(19) United States
(12) Patent Application Publication
(10) Pub. No.: US 2005/0068549 A1
(43) Pub. Date: Mar. 31, 2005

(54) Graphic user interface and method for selectively printing objects displayed on a display device

(76) Inventor: Denny Jaeger, Oakland, CA (US)

Correspondence Address: Harris Zimmerman;Law Offices of Harris Zimmerman, Suite 710, 1330 Broadway, Oakland, CA, 94612-2506, US

(21) Appl. No.: 10/672,404

(22) Filed: Sep. 26, 2003

(51) Int. Cl. G06F 15/00

(52) U.S. Cl. 358/1.2; 358/1.18

(57) ABSTRACT

The invention provides a graphic user interface and method for selectively printing graphic objects displayed on a display device that allows a user to simply create a geometric object (e.g., a rectangle) on the display device, which defines an area of the display device to be printed and represents the actual printable area of a selected print medium, and to print the graphic objects and/or portions of the graphic objects within the geometric object. The size and position of the geometric object can be changed by the user so that the user can readily determine the layout of the graphic objects to be printed and the relative sizes of the graphic objects with respect to the actual printable area of the selected print medium when the graphic objects are printed.

### FIELD OF THE INVENTION

The invention relates generally to computer programs, and more particularly to a graphic user interface and method for printing graphic elements displayed on a display device.

### BACKGROUND OF THE INVENTION

Printing is an essential feature of various computer programs, such as word processing programs, image processing programs, drawing programs and computer-assisted design (CAD) programs. The printing feature allows a user to make a hardcopy of objects (e.g., graphics, images and/or text) displayed on a monitor that have been manipulated into a desired layout with respect to relative position and size. As an example, the printing feature of a word processing program may be used to print displayed text and images in a particular arrangement such that the printed images are of certain size and the printed text is of certain font size, and the printed images and text are in the same displayed arrangement.

A concern with the printing feature of conventional computer programs is that the layout of objects displayed on the monitor may not be equivalent to the layout of objects when printed on a print medium, e.g., a sheet of paper. Thus, in general, the displayed layout of objects must be viewed in “print preview” mode to see a preview of the printed layout of objects before the layout is actually printed. However, in the “print preview” mode, the layout of objects cannot be modified. Thus, a user may have to go back and forth between the “print preview” mode and the regular view mode to modify the layout of objects.

Another concern with the printing feature of conventional computer programs is that the displayed objects may have to be rescaled and rearranged when an object is inserted into or deleted from the displayed layout. As an example, if a large picture is to be inserted into a displayed layout of text and graphics, the text and graphics may have to be made smaller and then rearranged to accommodate the picture in the layout. Thus, a user may have to continually manipulate the displayed objects to print the objects in a desired layout.

Still another concern is that existing printing approaches require a user to deal with dimensions of objects to be printed and the pages on which the objects are printed. When an object is partially outside a designated print page area, that object will not print. Then either the print page layout must be changed, e.g., to a larger page size or to a different orientation, or the objects on the printed page layout must be moved such that the objects are completely inside the print page layout. In addition, since the sizes of the displayed objects are not the actual print sizes of the objects when printed, rulers are often needed so that the user can determine the precise relative positions of the objects and the print sizes of the objects. Furthermore, existing printing approaches force the user to account for invisible borders that are not equidistant along the four sides of a page layout. If any object is placed in one of these invisible borders, that object will not print. These invisible borders are sometimes displayed in a “print preview” mode as dotted lines, but the user cannot remove the borders. The user is forced to continually account for the invisible borders and deal with these borders accordingly by, for example, adjusting the relative positions and sizes of displayed objects in the print page layout.

In view of these concerns, what is needed is a graphic user interface and method for selectively printing displayed graphic objects in a user-friendly manner without having to switch to a “print preview” mode or having to rescale some of the displayed objects.

### SUMMARY OF THE INVENTION

The invention provides a graphic user interface and method for selectively printing graphic objects displayed on a display device that allows a user to simply create a geometric object (e.g., a rectangle) on the display device, which defines an area of the display device to be printed and represents the actual printable area of a selected print medium, and to print the graphic objects and/or portions of the graphic objects within the geometric object. The size and position of the geometric object can be changed by the user so that the user can readily determine the layout of the graphic objects to be printed and the relative sizes of the graphic objects with respect to the actual printable area of the selected print medium when the graphic objects are printed.

A method in accordance with an embodiment of the invention includes creating a geometric object of a size determined by a user, the geometric object defining an area of the display device to be printed on a selected print medium, and converting the graphic objects within the geometric object to print driver data to print the graphic objects within the geometric object on the selected print medium.

An embodiment of the invention includes a storage medium, readable by a computer, tangibly embodying a program of instructions executable by the computer to perform method steps for selectively printing graphic objects displayed on a display device.

A graphical user interface in accordance with an embodiment of the invention includes a surface on which graphic objects are displayed, and a geometric object on the surface. The geometric object represents a printable area of a selected print medium. In addition, the geometric object defines an area of the surface to be printed on the selected print medium to enable printing of the graphic objects within the geometric object. The geometric object is user-manipulable with respect to at least a creation of the geometric object on the surface.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows a graphic user interface in accordance with an exemplary embodiment of the invention.

FIG. 2 illustrates a print area rectangle (PAR) that has been enlarged to surround an additional graphic object.

FIG. 3 illustrates a PAR that has been reduced in size to print a portion of a picture.

FIG. 4 illustrates a method for creating the PAR in accordance with the exemplary embodiment of the invention.

FIG. 5 shows the Info Canvas object for the PAR.

FIG. 6 shows a PAR in a VDACC object.

FIG. 7 shows a PAR in a VDACC object in the “multi page” mode.

FIG. 8 illustrates horizontal and vertical spacings of a multi-page mode PAR in a VDACC object.

FIG. 9A shows an overview window when the visible area of a VDACC object cannot display the entire area of a PAR.

FIG. 9B illustrates moving the smaller rectangle of an overview window to a different location within the larger rectangle of the overview window.

FIG. 10A illustrates moving the cursor to an intersection of an array of rectangles (i.e., a multi-page mode PAR) in a VDACC object to change the size of the rectangles, which changes the cursor into a double arrow.

FIG. 10B shows the array of rectangles of FIG. 10A after the rectangles have been decrease in size.

FIG. 10C shows the array of rectangles of FIG. 10A after the rectangles have been increased in size.

FIG. 11A shows a VDACC object snapped to a PAR.

FIG. 11B shows the PAR of FIG. 11A converted to a multi-page mode PAR.

FIG. 11C illustrates changing the size of rectangles of the multi-page mode PAR of FIG. 11B such that four rectangles fit into the visible area of the VDACC object.

FIG. 11D illustrates changing the size of rectangles of the multi-page mode PAR of FIG. 11B such that nine rectangles fit into the visible area of the VDACC object.

FIG. 12A shows a clockwise arrow that intersect four rectangles of the multi-page mode PAR of FIG. 11C for selecting the printing sequence of the four rectangles.

FIG. 12B shows a counterclockwise arrow that intersect four rectangles of the multi-page mode PAR of FIG. 11C for selecting the printing sequence of the four rectangles.

FIG. 12C shows a Z-shaped arrow that intersect four rectangles of the multi-page mode PAR of FIG. 11C for selecting the printing sequence of the four rectangles.

FIG. 13 is a diagram of a computer system in which the invention has been implemented.

FIG. 14 is a flow chart of a process for handling a left mouse click event in the Blackspace environment.

FIG. 15 is a flow chart of a process for handling a left mouse double click event in the Blackspace environment.

FIG. 16 is a flow chart of a process for handling the activation of actual size feature.

FIG. 17 is a flow chart of a process for handling a left mouse click event on an overview window.

FIG. 18 is a flow chart of a process for handling a left mouse double click event to activate the “snap to” feature.

FIG. 19 is a flow diagram of a method for selectively printing displayed graphic objects in accordance with an embodiment of the invention.

### DETAILED DESCRIPTION

The present invention provides a user-friendly graphic user interface and method for selectively printing displayed objects in an operating environment of a computer system or any computing system with a display. In an exemplary embodiment, the invention allows a user to simply draw a special rectangle, referred to herein as a Print Area Rectangle (PAR), in the operating environment to define an area to be printed. Although a PAR is illustrated and described herein as a rectangle, the PAR can be any geometric object that defines an area of any geometrical shape using, for example, solid lines, dotted lines or corners. The size and position of the PAR is user-manipulable so that the user can easily modify the area to be printed. When the PAR is initiated for printing, displayed objects and/or portions of displayed objects that are within the perimeter of the PAR are printed. As described in more detail below, the objects and/or portions of objects within the PAR are automatically rescaled in proportion to the displayed size of the PAR. Thus, the invention eliminates the need for the user to resize displayed objects to change the sizes of the printed objects. In addition, since the user can see the objects and/or portions of objects that are to be printed, the invention eliminates the need to switch between a “print preview” mode and a standard viewing mode to see a preview of the printed objects before the objects are actually printed, as is the case in conventional computer programs.

As used herein, the term “objects” include recognized graphic objects (e.g., stars, squares, circles, arrows, etc.), free drawn objects (sketches, drawings, lines, etc.), pictures in various file format (.png, .jpg, .bmp, .gif, etc.), graphic control devices (switches, faders, knobs, joysticks, etc.), videos in various file format (.mpg, .avi, .mov, etc.), text, and other graphic objects or portions of graphic objects that are displayed on a display device.

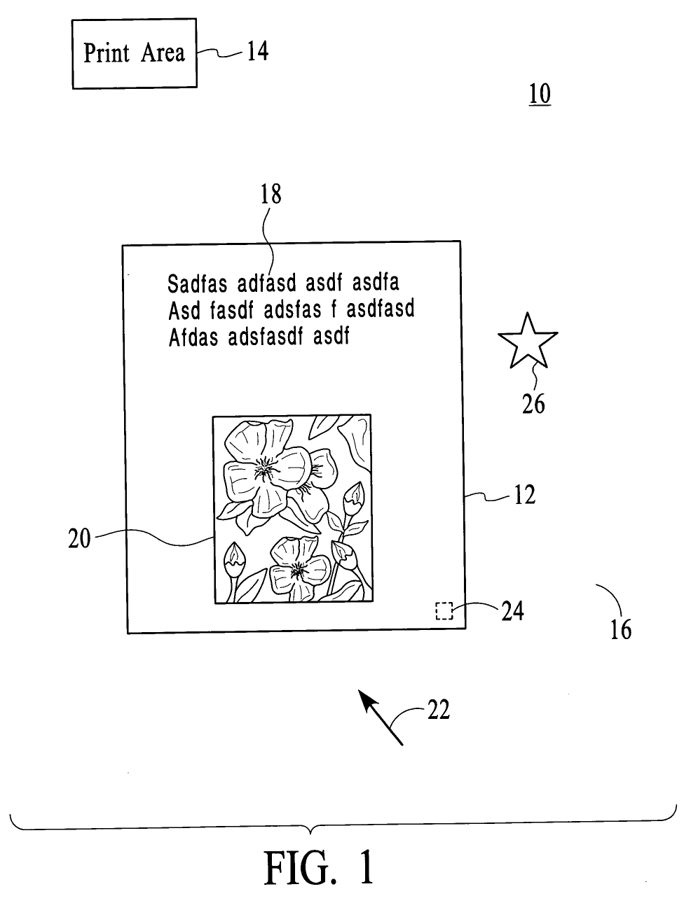

In FIG. 1, a graphic user interface 10 in accordance with the exemplary embodiment is shown. The graphic user interface 10 includes a PAR 12 and a Print Area switch 14 in a computer operating environment 16 referred to herein as “Blackspace” environment. The word “Blackspace” is a trademark of the NBOR Corporation. Blackspace environment presents one universal drawing surface that is shared by all graphic objects within the environment. Blackspace environment is analogous to a giant drawing “canvas” on which all graphic objects generated in the environment exist and can be applied. Each of these graphic objects can have a user-created relationship to any or all the other objects. There are no barriers between any of the objects that are created for or exist on this canvas. However, the invention is not limited to the Blackspace environment and can be implemented in any computer operating environment.

The PAR 12 is a graphic object that represents a set proportion or ratio of height to width, which corresponds to the actual printable area of a selected print medium. A print medium is any material on which graphic objects can be printed, such as transparency films and sheets of paper. The printable area of a selected print medium depends on the specification of a printer. Thus, a printable area of a selected print medium can vary from one printer to the next, depending on which printer is used by the computing system embodying the invention. However, the PAR 12 conforms to the printable area of a selected print medium for the printer that is being used to print graphic objects within the perimeter of the PAR. Therefore, regardless of the printer being used, the PAR 12 represents the actual printable area that the printer can print on the selected print medium. When the PAR 12 is activated for printing, the graphic objects within the perimeter of the PAR are rescaled to be proportional to the printable area in the same ratio as the displayed graphic objects are to the PAR, and the graphic objects within the perimeter of the PAR are converted to print driver data to drive a selected printer. As used herein, print driver data is any signal that represents the graphic objects selected for printing so that the graphic objects can be printed on a print medium by a printer. Thus, the printed size of any displayed object can be increased or decreased by making the PAR 12 that surrounds that object smaller or larger, respectively. In addition, the PAR 12 can be moved so that the objects within the perimeter of the PAR are at different locations within the PAR, which would correspond to the locations in the printable area of a print medium when the objects are printed. Alternatively, the PAR 12 can be moved to select different displayed objects to be printed.

In FIG. 1, the PAR 12 is positioned such that text 18 and a picture 20 are within the perimeter of the PAR. Thus, when the PAR 12 is initiated for printing, the text 18 and picture 20 will be printed on a printable area of a selected print medium such that that the text and picture are in the same proportion as to the printable area as the displayed text and picture are to the PAR. Thus, the printed sizes of the text 18 and picture 20 can be controlled by changing the size of the PAR 12, as long as the text and picture are positioned such that they at least intersect the perimeter of the PAR. If the size of the PAR 12 is increased, then the text 18 and picture 20 will be printed in smaller sizes. Conversely, if the size of the PAR 12 is decreased, then the text 18 and picture 20 will be printed in larger sizes. In the exemplary embodiment, the PAR 12 can be made larger or smaller by moving the cursor 22 to a resize region 24 at the bottom right corner of the PAR, which changes the cursor into a double arrow, and then moving the arrow in a diagonal direction, while the mouse is left-clicked. As an example, the resize region 22 of the PAR 12 may be an 8×8 pixel region.

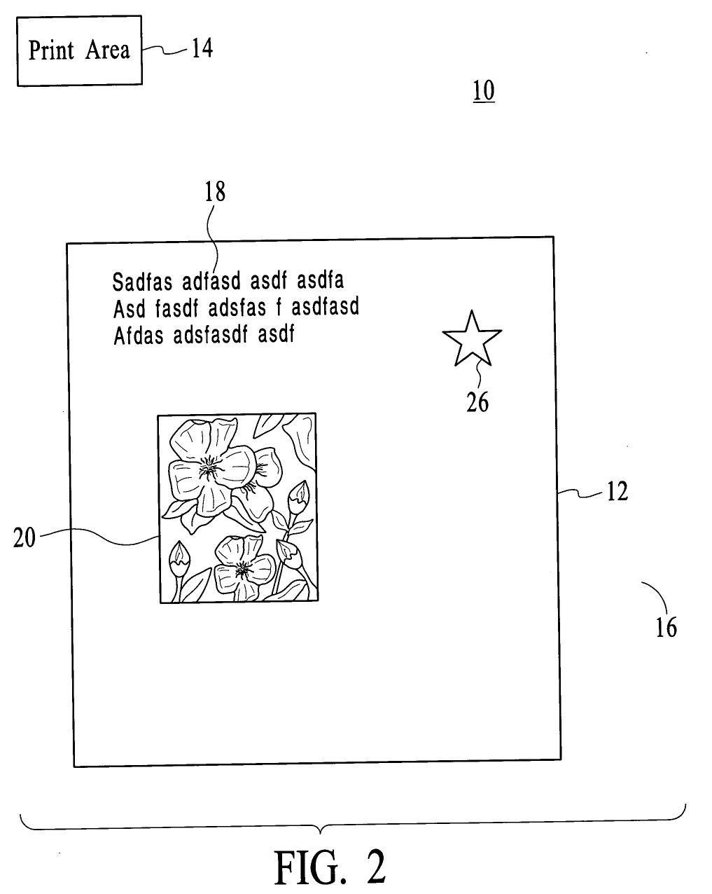

As stated above, the PAR 12 can be moved to select different displayed objects to be printed. In FIG. 1, if the PAR 12 is moved such that only the text 18 is within the perimeter of the PAR and then printing is initiated, the text will be printed without the picture 20. Similarly, if the PAR 12 is moved such that only the picture 20 is within the perimeter of the PAR 12 and then printing is initiated, the picture will be printed without the text 18. If the PAR 12 is too small to surround the desired objects, e.g., the text 18, the picture 20 and a graphic object 26, to be printed on a single print medium, the size of the PAR can be increased to accommodate all the objects, as illustrated in FIG. 2.

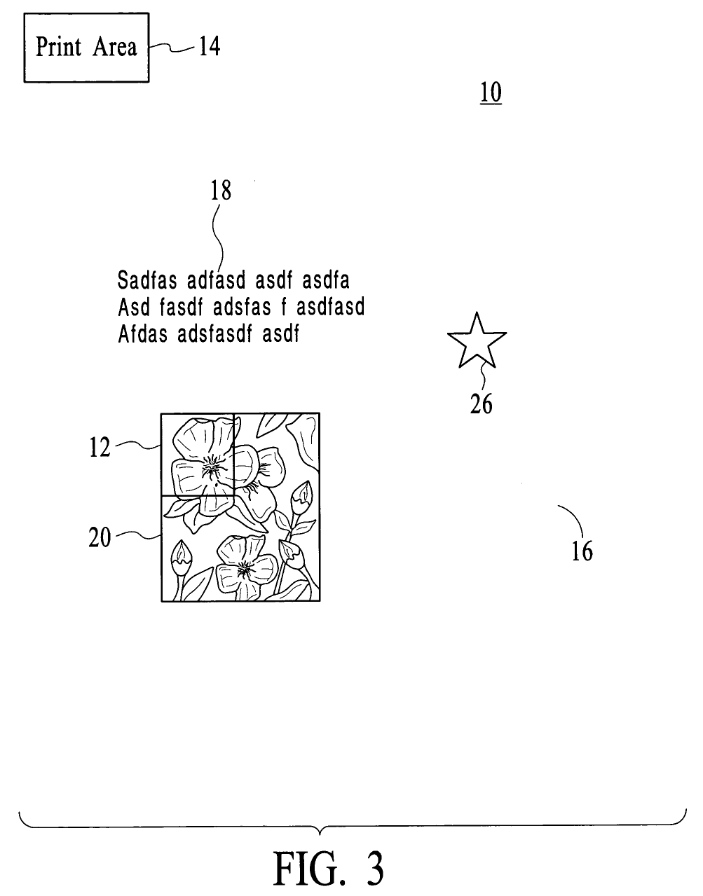

In situations where the user wants only a portion of an object to be printed, the PAR 12 can be changed in size to equal the size of that object portion and positioned on the object such that the perimeter of the PAR surrounds the portion of the object to be printed. As an example, if the user wants only to print the upper left quarter portion of the image 20, then the PAR 12 can be made smaller to equal the size of that portion and positioned on the picture so that the perimeter of the PAR surrounds the upper left quarter portion of the image, as illustrated in FIG. 3. In this configuration, when the PAR 12 is initiated for printing, the upper left quarter portion of the image 20 will be rescaled to fill the entire printable area of a print medium as defined by the printer being used. Thus, the invention eliminates the need to first crop a picture to print only a portion of that picture.

In conventional computer programs, a fixed area is typically presented to a user so that the user can create or insert objects into this area for printing. One of the problems with this approach is that if this fixed area is filled with objects and the user wants to insert additional objects, then one or more of the objects within the fixed area must be resized to accommodate the additional objects. This can be a challenging task if the relative sizes of the objects are to be maintained. In this case, each object must be resized so that there is not enough space in the fixed area to accommodate the additional object and the relative sizes of the objects are maintained.

However, using the present invention, a user can insert additional objects into an existing layout of objects that fills the entire printable area by simply increasing the size of the PAR 12 to include the additional objects since the printable area is represented by the PAR. Thus, there is no need to resize one or more objects in the existing layout to accommodate the additional objects.

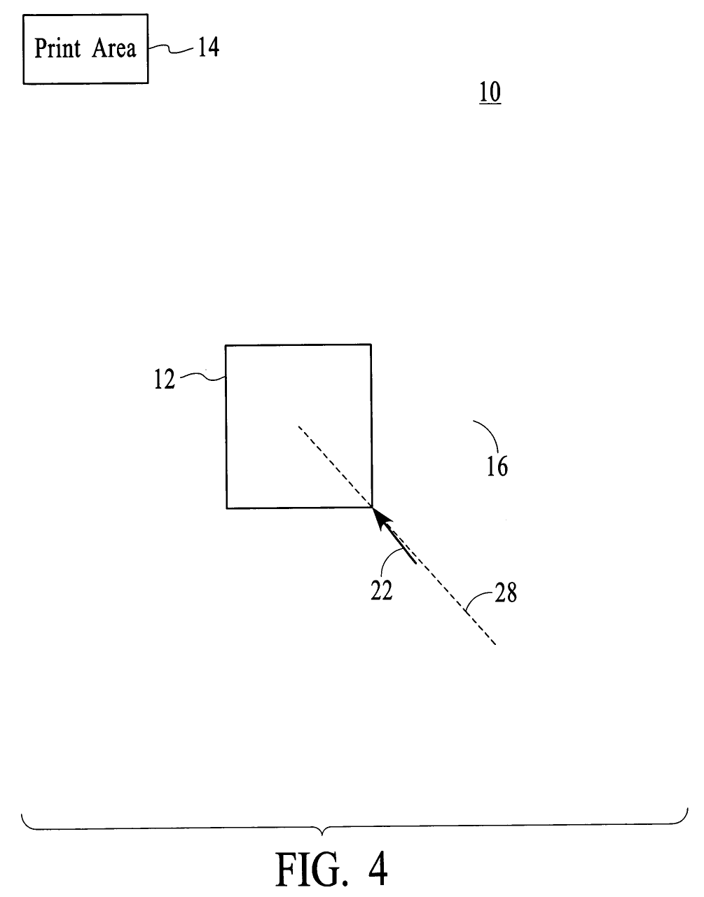

Turning back to FIG. 1, the Print Area switch 14 is a graphic control device that is used to create the PAR 12. In the exemplary embodiment, only one PAR can be created at a time. However, in other embodiments, any number of PARs can be created using the same Print Area switch or using additional Print Area switches. In the Blackspace environment, the Print Area switch 14 can be created by first creating a blank switch, for example, using Object Points (see pending U.S. patent application Ser. No. 10/103,680, entitled “Method for Controlling Electronic Devices Using Object Point Tool”, filed on Mar. 22, 2002, which is incorporated herein by reference) and then typing or drawing “print area” on the blank switch. As illustrated in FIG. 4, when the Print Area switch 14 is activated, a PAR 12 can be drawn or created by left-clicking on the mouse and then diagonally dragging the cursor 22 along a phantom line 28, which creates the PAR in the form of a blue rectangle. The color blue for the PAR 12 is the default setting, but the PAR may be created in other colors. The size of the PAR 12 depends on the diagonal distance traveled by the cursor 22 while the left mouse button is pressed or clicked. Thus, the size of the PAR 12 can be increased by continuing to diagonally drag the cursor 22 while the mouse is left-clicked. The default setting for the minimum size of the PAR 12 is 20 pixels wide.

Once the PAR 12 is created, the PAR can be moved or resized by the user as long as the Print Area switch 14 is activated. If the Print Area switch 14 is not activated, then the PAR 12 cannot be resized or moved. One reason to render the PAR unmovable is to enable a user to freely place and reposition any one or more objects in the PAR without the risk of moving the PAR. Thus, the PAR becomes a set boundary where the user can place objects within the boundary or partially within the boundary to be printed. In fact, the PAR 12 cannot be selected for any reason when the Print Area switch 14 is not on. If the PAR 12 is on another graphic object, the PAR 12 can be moved by moving the cursor 22 near the perimeter or edge of the PAR, left-clicking on the mouse and then dragging the PAR using the mouse. Although the perimeter of the PAR 12 is one-pixel wide, in the exemplary embodiment, there is an edge area around the perimeter of the PAR 12 such that the PAR perimeter is at the center of the edge area. This edge area can be any desired width, e.g., 8 pixels wide, and can be changed by a user using a menu or its equivalent. The edge area allows the user to select or “grab” the PAR 12 using the cursor 22. However, if the PAR 12 is on a blank background, i.e., a blank Blackspace canvas 16, then the PAR can also be grabbed by left-clicking on the mouse when the cursor 22 is anywhere within the perimeter of the PAR.

There are two methods to delete the PAR 12. The first method is to left-click the mouse when the cursor 22 is positioned at the lower right corner of the PAR, which changes the cursor into a double arrow, and then diagonally dragging the cursor to at least the upper left corner of the PAR. If this method is executed correctly, the PAR 12 will continually decrease in size until the PAR disappears from the screen. In a similar fashion, the PAR 12 can be deleted right after the PAR is created (i.e., the mouse is still left-clicked from creating the PAR) by diagonally moving the cursor 22 back to the starting point of the cursor from which the PAR was created.

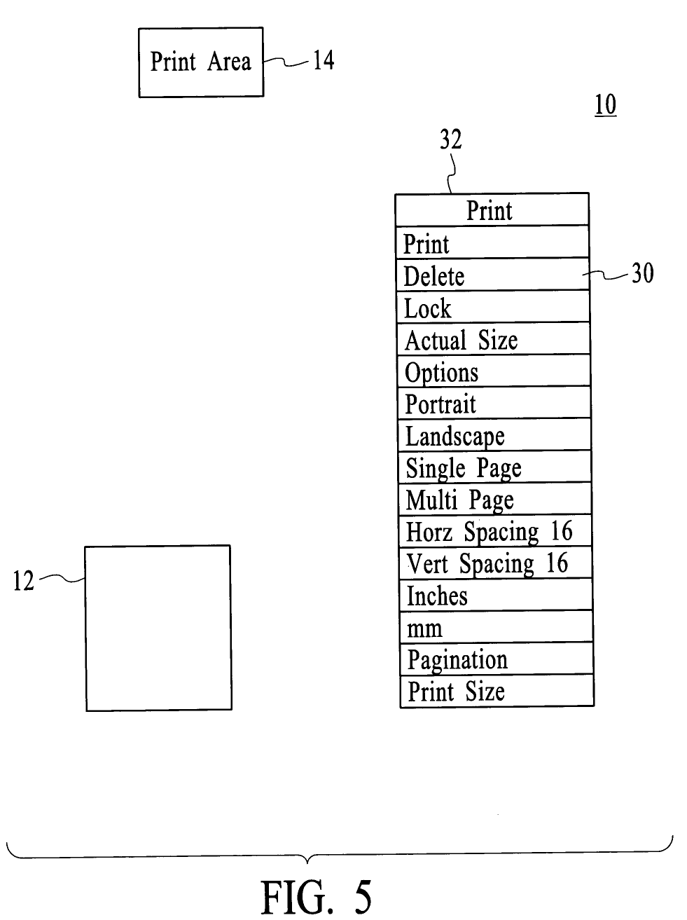

The second method is to activate a delete function for the PAR 12 in a menu associated with the PAR. In the exemplary embodiment, the second method involves activating a “delete” entry 30 in an “Info Canvas” object 32 associated with the PAR 12, as illustrated in FIG. 5. The term “Info Canvas” is a trademark of NBOR Corporation. The Info Canvas object 32 associated with the PAR 12 provides entries to change the properties of the PAR or control functions associated with the PAR. Thus, the Info Canvas object serves as a menu for using the PAR 12. For more information about Info Canvas objects, see simultaneously filed U.S. patent application Ser. No. xx/xxx,xxx, entitled “Intuitive Graphic User Interface with Universal Tools”, which is incorporated herein by reference.

In the exemplary embodiment, the Info Canvas object 32 for the PAR 12 can only be seen when the Print Area switch 14 is turned on by right-clicking on the mouse when the cursor 22 is on the Print Area switch or in the PAR (or on the predefined area around the perimeter of the PAR when the PAR is another graphic object). When the Print Area switch 14 is turned off, the Info Canvas object 32 for the Print Area switch is the same for any basic switch in the Blackspace environment. In addition, the Info Canvas object 32 cannot be made to appear by right-clicking on the mouse when the cursor 22 is in the PAR or the predefined area around the perimeter of the PAR.

The Info Canvas object 32 in FIG. 5 includes entries and categories for the user to change the properties of the PAR 12 or control functions associated with the PAR. A category of an Info Canvas object includes a number of entries associated with that category. The entries and categories of the Info Canvas object 32 are now described. In the exemplary embodiment, the color of an entry indicates whether that entry is activated or deactivated. As an example, the color green indicates that an entry is turned on, while the color gray indicates that the entry is turned off.

Print. When the “print” entry is turned on by left-clicking on the mouse when the cursor is on this entry, this brings up a print menu to print whatever is inside the perimeter of the PAR 12. The print menu may be a conventional print menu that is commonly used in conventional computer programs when the print function is activated. As an example, the print menu may allow a user to select the printer and the number of copies to be printed.

Delete. When the “delete” entry is turned on, the PAR 12 is deleted from the screen, as described above.

Lock. When the “lock” entry is turned on, the PAR 12 is locked to a [Visual or Virtual] Display and Control Canvas (VDACC) object so that the PAR scrolls within the VDACC object in the same manner as other graphic object in the VDACC object. The term “VDACC” is a trademark of NBOR Corporation. A VDACC object includes a workspace surface or canvas that may be larger than the visible or viewable area of the VDACC object. Thus, the VDACC object allows a user to scroll the visible area to view graphic objects or contents in the VDACC object that were hidden from the visible area. The “lock” entry enables a user to freely drag objects, pictures, text, etc., in and out of the visible area of the VDACC object without risking moving the PAR 12, which may be specifically positioned around certain objects in the VDACC object. For more information about VDACC objects, see simultaneously filed U.S. patent application Ser. No. xx/xxx,xxx, entitled “Intuitive Graphic User Interface with Universal Tools”. The “lock” entry will be described further below with reference to the “single page” entry.

Actual Size. When the “actual size” entry is turned on, the PAR 12 immediately changes its size to equal the actual printable area of the selected page size in the Info Canvas object 32 for the PAR. This entry can be activated when the PAR 12 is on a blank Blackspace canvas 16 or when the PAR is on a VDACC object. When the PAR 12 in on a VDACC object and this entry is activated, the width of the VDACC object is made to equal the width of the PAR. If the width of the PAR 12 is too large to be displayed on screen, then the width of the VDACC object is made to fit the screen and an overview window is displayed, as described in more detail below.

Options. This is the category for printing options with the following entries.

Portrait. Turning on the “portrait” entry selects the portrait orientation for printing. In other words, this entry changes the PAR 12 into a portrait proportion.

Landscape. Turning on the “landscape” entry selects the landscape orientation for printing. In other words, this entry changes the PAR 12 into a landscape proportion.

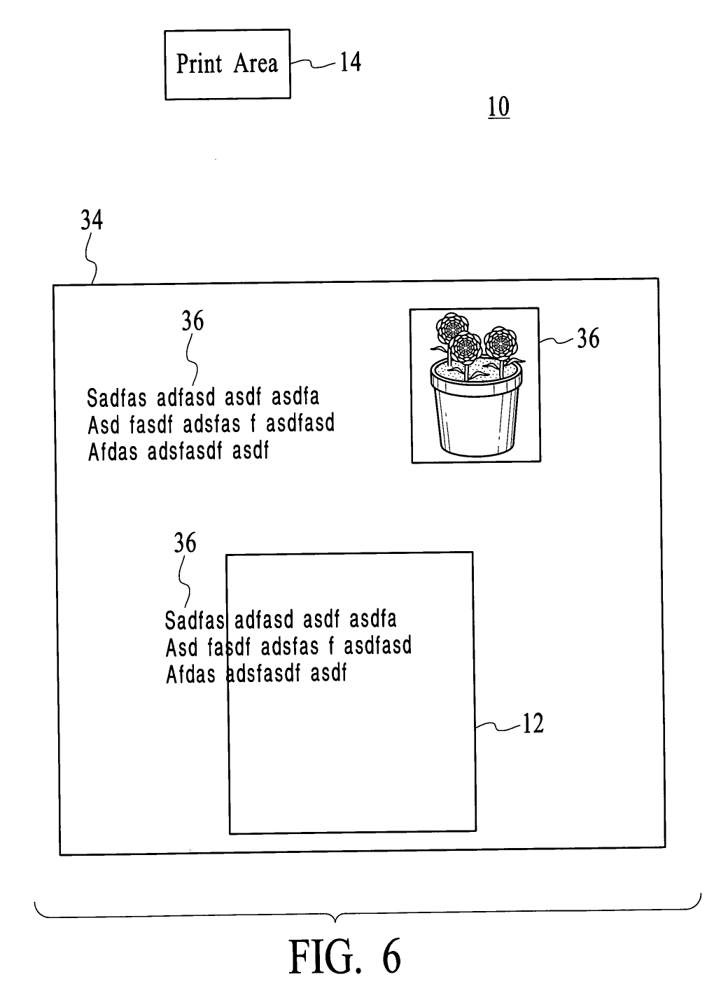

Single Page. Selecting the “single page” entry makes the PAR 12 to define a single page only. As described above with respect to the “lock” entry, the PAR can be locked to a VDACC object. As illustrated in FIG. 6, when a single page PAR 12 is not locked to a VDACC object 34, the single page PAR is fixed so that the contents 36 of the VDACC object can be scrolled without moving the PAR. Thus, the contents of the PAR 12 can be changed by scrolling the contents 36 of the VDACC object 34 with respect to the fixed PAR 12. Since the PAR 12 can be used to print whatever is within the perimeter of the PAR, a user can scroll the contents 36 of the VDACC object 34 to move different contents in and out of the fixed PAR and then print when the desired contents are within the perimeter of the PAR. When the single page PAR 12 is locked to the VDACC object 34, the single page PAR can be scrolled with the contents 36 of the VDACC object. However, the PAR 12 can be dragged within the VDACC object 34 and resized at will to surround any objects within the VDACC object that a user desires to print.

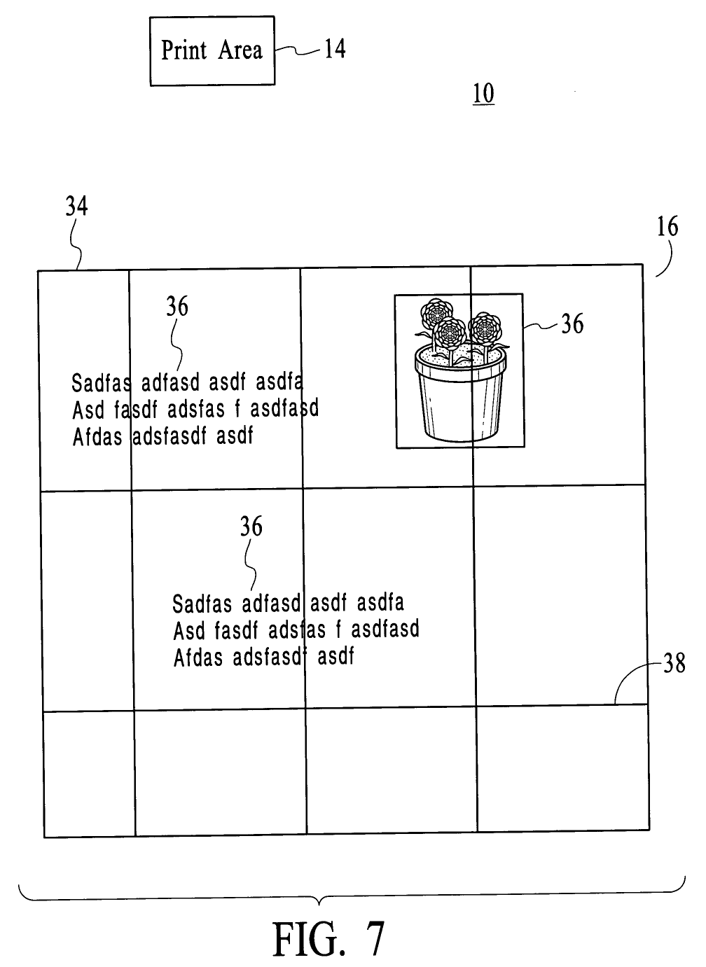

Multi Page. Selecting the “multi page” entry enables the PAR 12 to divide the contents of a VDACC object into multiple pages. As illustrated in FIG. 7, turning on this entry changes a single page mode PAR 12 (not shown in FIG. 7) in a VDACC object 34 into a multi-page mode PAR 38 in the form of an array of multiple rectangles, where each rectangle represents the actual printable area of a single print medium. The multi-page mode PAR 38 can also be created from scratch in a VDACC object in a manner similar to the creating of a single page mode PAR, except that the “multi page” entry is activated. The print size and proportion of these rectangles are set by turning on the appropriate entries in the Info Canvas object 32 of the PAR 12. In the exemplary embodiment, the rectangles of the array are arranged in the VDACC object such that the rectangles extend in both vertical and horizontal directions. However, in other embodiments, the rectangles of the array may be arranged in any configuration. In addition, in other embodiments, the multi-page mode PAR may be in the form of an array of any geometric objects other than rectangles.

The “multi page” feature will be described in more detail below. This feature may also be available when the PAR 12 is outside of the VDACC object 34, i.e., on the blank Blackspace canvas 16.

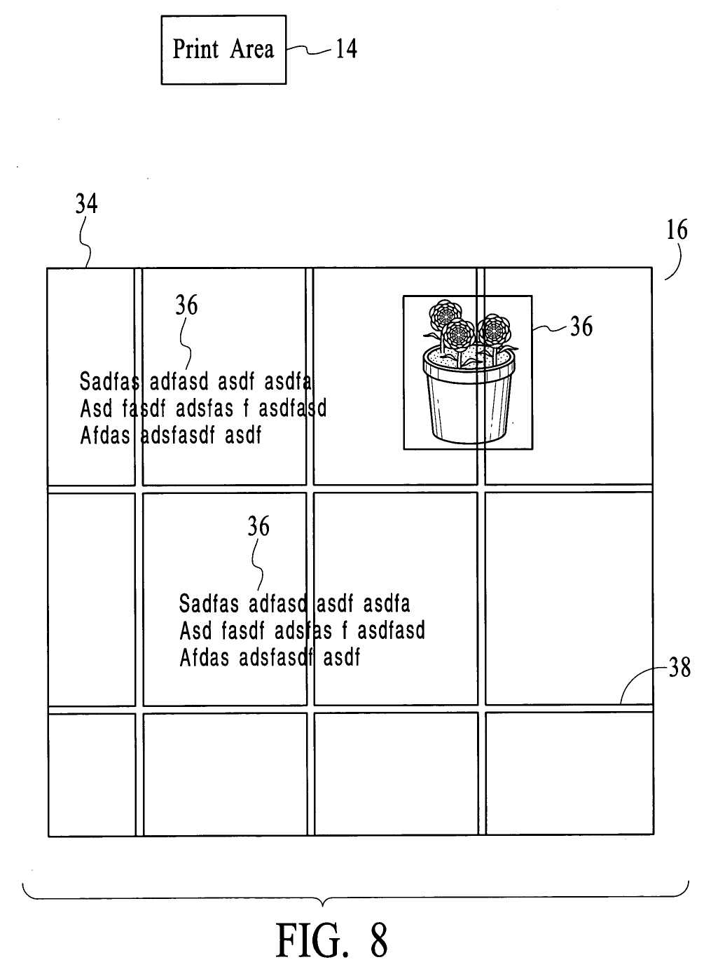

Horz Spacing. This entry creates a horizontal spacing between each rectangle of the array 38 of multiple rectangles by a number of pixels, which can be controlled by typing a number after the text “Horz Spacing” in the entry. In FIG. 5, the number “16” appears after the text “Horz Spacing”. In this case, the horizontal spacing is set at 16 pixels to create 16 pixel wide spaces between the columns of array rectangles, as illustrated in FIG. 8. These horizontal spaces are not part of the printable areas represented by the array rectangles. Thus, any partial or complete graphic object in the horizontal spaces will not be printed when the multi-page mode PAR 38 is activated for printing.

Vert Spacing. This entry creates a vertical spacing between each rectangle of the grid of multiple rectangles by a number of pixels, which can be controlled by typing a number after the text “Vert Spacing” in the entry. In FIG. 5, the number “16” appears after the text “Vert Spacing”. In this case, the vertical spacing is set at 16 pixels to create 16 pixel wide spaces between the rows of array rectangle, as illustrated in FIG. 8. Similar to the horizontal spaces, these vertical spaces are not part of the printable areas of the array rectangles. Thus, any partial or complete graphic objects in the vertical spaces will also not be printed when the multi-page mode PAR 38 is activated for printing.

Inches. This entry selects inches as the measurement unit for the PAR 12.

mm. This entry selects millimeters as the measurement unit for the PAR 12.

Pagination. This is the category for pagination. The pagination category may include entries for a user to insert page numbers, including the location and format of the page numbers.

Print Size. This is the category for selecting print size, i.e., the size of the paper. This category may include entries for letter size (8.5″ by 11″), legal size (8.5″ by 14″), A4 size (8.27″ by 11.69″) and other sizes, including custom sizes.

The categories and entries of the Info Canvas object 32 for the PAR 12 are not limited to those described above, and thus, the Info Canvas object may include additional categories and/or entries. As an example, the “options” category may include additional entries to select the measurement unit for the PAR 12, such as a “pica” entry and a “pixel” entry.

Using the PAR in a VDACC Object

The PAR 12 can first be created on a blank Blackspace surface 16 and then moved into a VDACC object. Alternatively, the PAR 12 can be created in the VDACC object. The PAR 12 in a VDACC object can be viewed in a “single page” mode or a “multi page” mode using the “single page” and “multi page” entries in the Info Canvas object 32 for the PAR.

A. “Snap To” Feature.

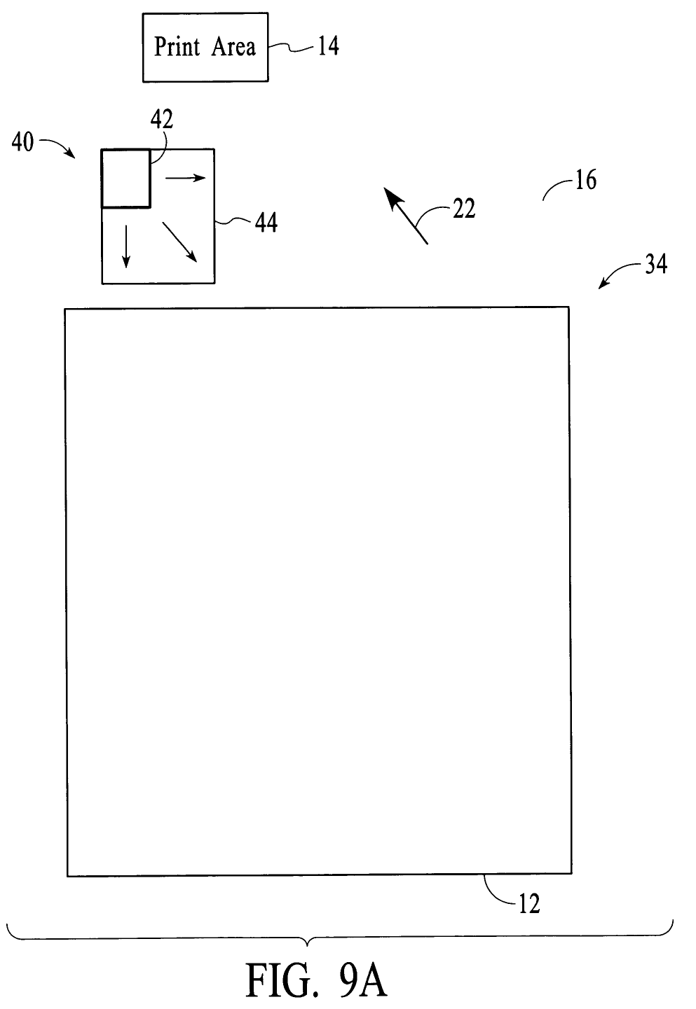

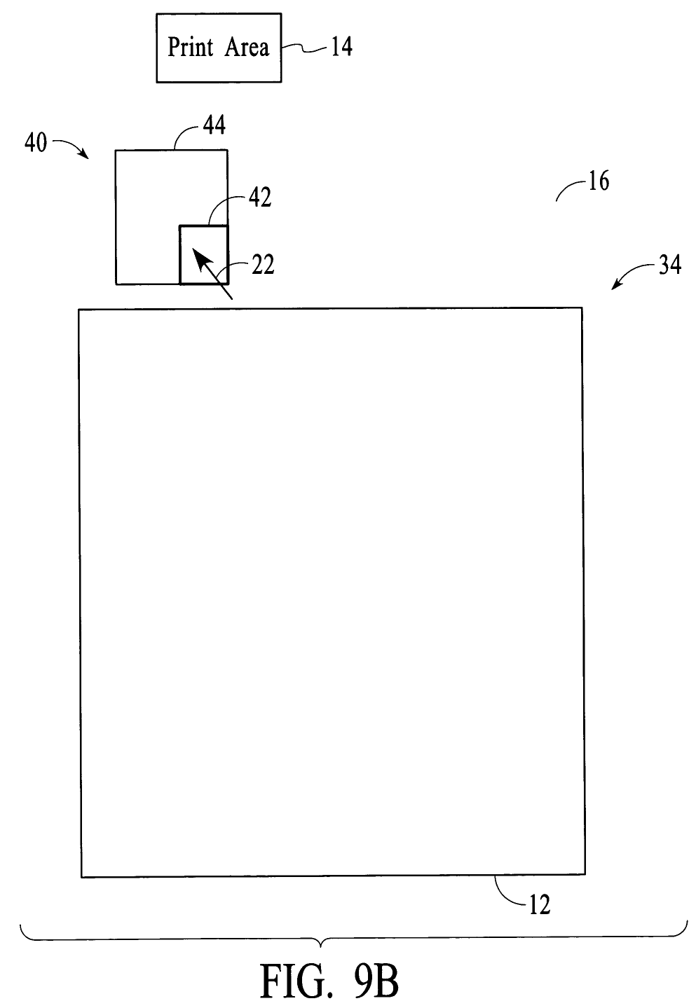

When the edge area of a single page mode PAR in a VDACC object is double left-clicked on the mouse or its equivalent, the size of the VDACC object is changed to the size of the PAR. If the PAR is too large to fit on the screen, then the size of the VDACC object is changed accordingly and an overview window is displayed. In FIG. 9A, a VDACC object 34 that has been snapped to a PAR 12 is shown. An overview window 40 is also shown. The overview window 40 includes a smaller rectangle 42 of one color within a larger rectangle 44 of another color. In the exemplary embodiment, the smaller rectangle 42 is green and the larger rectangle 44 is red. However, these rectangles 42 and 44 of the overview window 40 may be displayed in other colors. The larger rectangle 44 represents the entire PAR 12 or the printable area of a selected print medium. The smaller rectangle 42 represents the portion of the PAR 12 that is displayed in the visible area of the VDACC object 34. The overview window 40 can be moved on the screen by left-clicking on the mouse when the cursor is on the overview window and then dragging the overview window to a desired onscreen location.

In FIG. 9A, the smaller rectangle 42 of the overview window 40 is at the upper left quarter of the larger rectangle 44. Thus, a corresponding portion of the PAR 12 is displayed on the VDACC object 34. The smaller rectangle 42 of the overview window 40 can be moved by the user to any position within the larger rectangle 44 by left-clicking on the mouse when the cursor 22 is on the smaller rectangle and then moving the cursor to the desired position within the larger rectangle, as indicated by the arrows (not displayed on screen) in the larger rectangles. In FIG. 9B, the smaller rectangle 42 has been moved to the bottom right quarter of the larger rectangle 44. In response, the VDACC object 34 will automatically scroll so that a corresponding portion of the PAR 12 is displayed on the VDACC object.

In the “multi page” mode, the user can view the printable area of the next page (i.e., next rectangle in the array of rectangles) 38 by scrolling the VDACC object 34 until the contents of the VDACC object that correspond to this printable area is visible on the VDACC object. Again, different regions of this printable area can be made visible by moving the smaller rectangle of the overview window within the larger rectangle.

B. “Actual Size” Feature in Single Page Mode.

When a single page PAR is in a VDACC object, turning on the “actual size” feature changes the size of the PAR to the size of the actual printable area for the selected page size. In addition, the width of the VDACC object changes to the size of the actual printable area. As an example, if the letter size and the portrait orientation are selected, the width of the VDACC object on screen will change to approximately 8.5 inches. However, the height of the VDACC object will not change when the “actual size” feature is activated. This enables users to control the top edge placement of a VDACC object, and thus, control the use of the Blackspace canvas about the VDACC object.

If there is not enough space on the screen to display the VDACC object in the same width size as the actual printable area, the viewable width of the VDACC object is set to the screen width with a small border. Whenever, the VDACC object is not displayed in the same size as the actual printable area (width and/or length), an overview window is displayed to show the viewable area of the VDACC object in relation to the actual printable area.

C. “Multi Page” Feature

As described above, the “multi page” feature can be used to create a multi-page mode PAR in a VDACC object in the form of an array of rectangles, as illustrated in FIG. 7. Each rectangle of the array represents a single printable area of a print medium. Thus, the array of rectangles can be used to selectively print partial or complete graphic objects within different rectangles of the array on multiple print media.

A multi-page mode PAR can be created in a VDACC object by activating the “multi page” entry in the associated Info Canvas object and then creating the multi-page mode PAR on the VDACC object in the same manner as a single page mode PAR. Alternatively, a multi-page mode PAR can be created in a VDACC object by first creating a single page mode PAR on the Blackspace canvas, moving the single page mode PAR into the VDACC object, and then activating the “multi page” feature. When a multi-page mode PAR is created in a VDACC object, the multi-page mode PAR in the form of an array of rectangles is drawn on the entire possible workspace canvas of that VDACC object, not just the current visible workspace canvas (a workspace canvas may be larger than the visible or viewable area of a VDACC object). Thus, if the workspace canvas of the VDACC object is increased by enlarging the VDACC object or by inserting additional objects into the VDACC object, the array of rectangles will already be on the newly created portion of the increased workspace canvas.

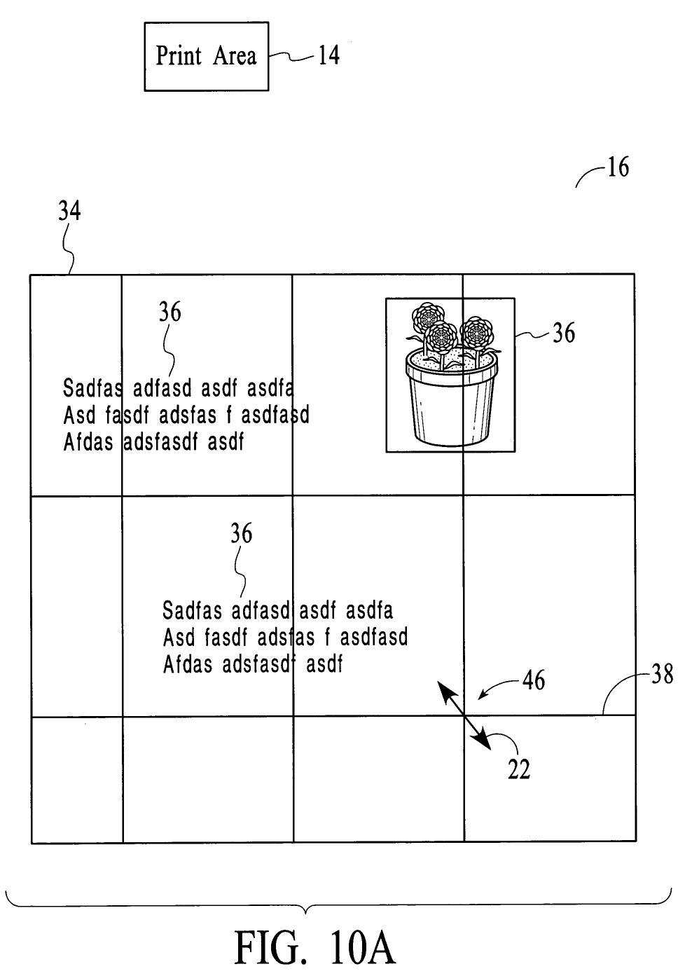

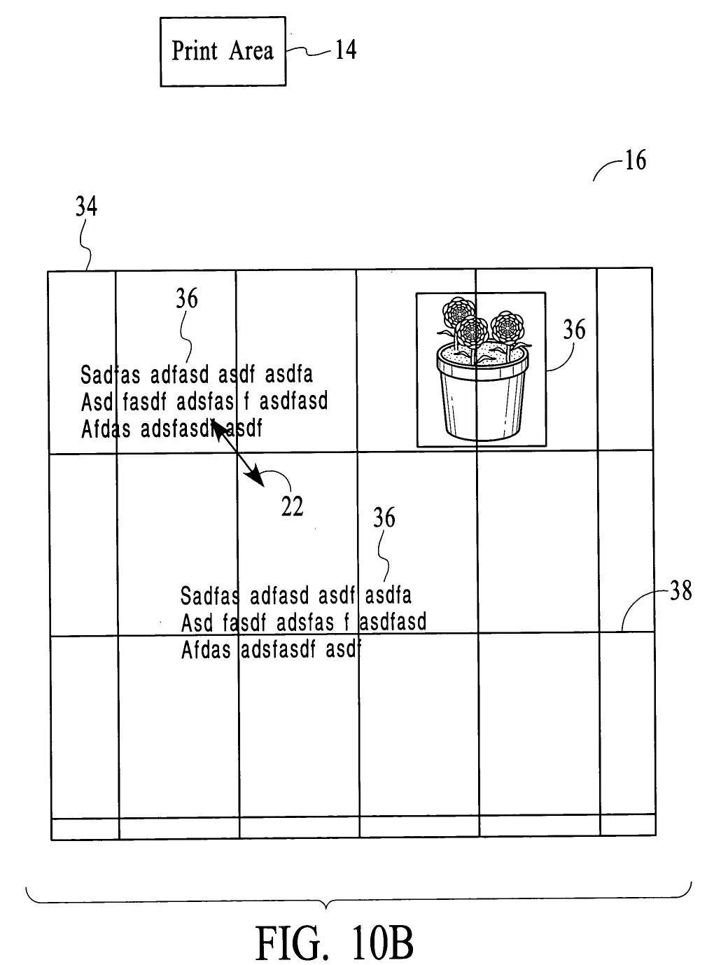

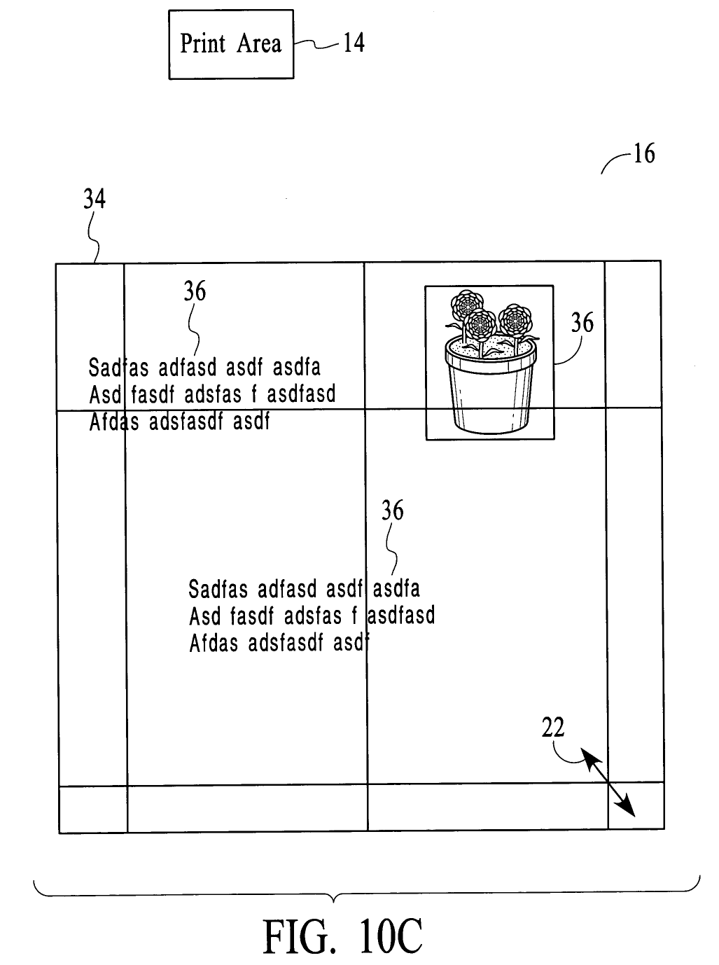

The displayed size of the rectangles of a multi-page mode PAR can be collectively changed by a user. In FIG. 10A, a multi-page mode PAR 38 in a VDACC object 34 in the form of an array of rectangles is show. The displayed size of the rectangles of the array 38 can be collectively changed by moving the cursor 22 to an intersection 46 (or a corner of an array rectangle) on the array, which changes the cursor into a diagonal double arrow at the intersection, and then left-clicking on the mouse and dragging the double arrow cursor diagonally. If the double arrow cursor 22 is diagonally moved in an upward and leftward direction, the rectangles of the array 38 are decreased in size, as illustrated in FIG. 10B. If the double arrow cursor 22 is diagonally moved in a downward and rightward direction, the rectangles of the array 38 are increased in size, as illustrated in FIG. 10C.

Similar to the single page mode PAR, the relative size of the displayed array rectangles with respect to the graphic objects of the VDACC object 34 within the rectangles defines the printed size of objects within the rectangles. Thus, if the size of the array rectangles is decreased, the objects within the grid rectangles will be rescaled and printed in a large size. Conversely, if the size of the grid rectangles is increased, the objects within the grid rectangles will be rescaled and printed in a smaller size. In one embodiment, each rectangle in the array represents the same printable area size for the selected print size in the Info Canvas object for the PAR as the original single page mode PAR.

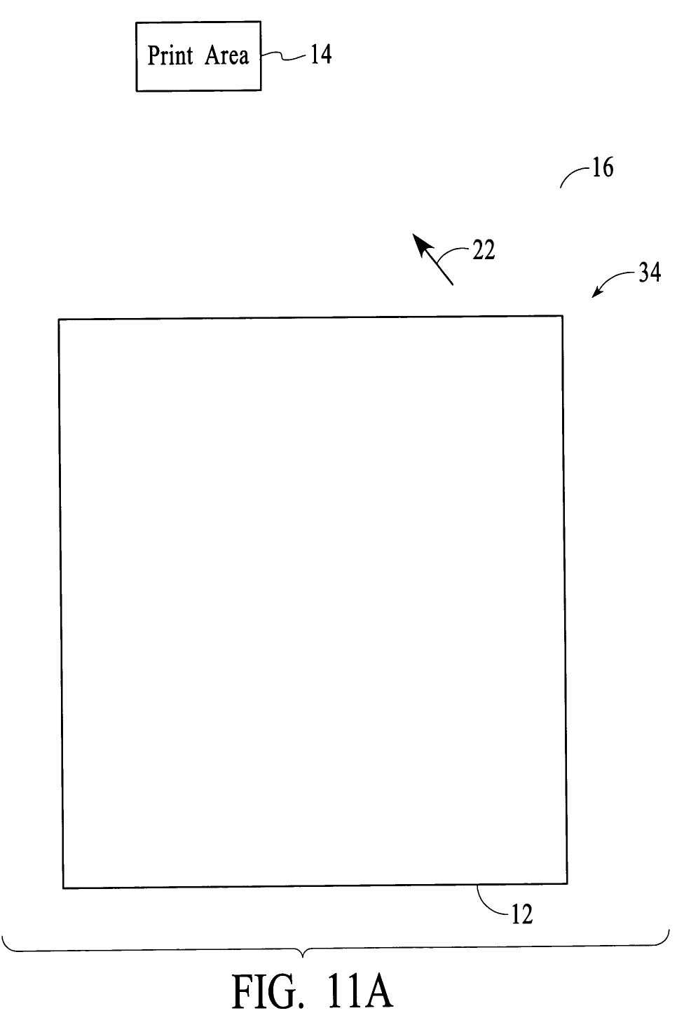

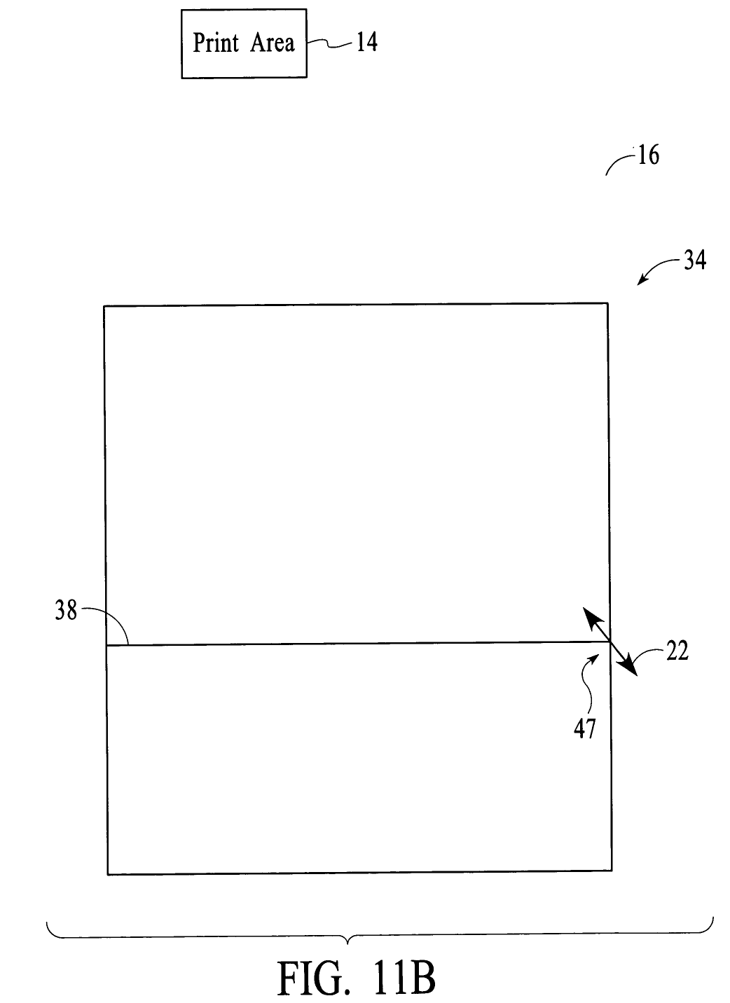

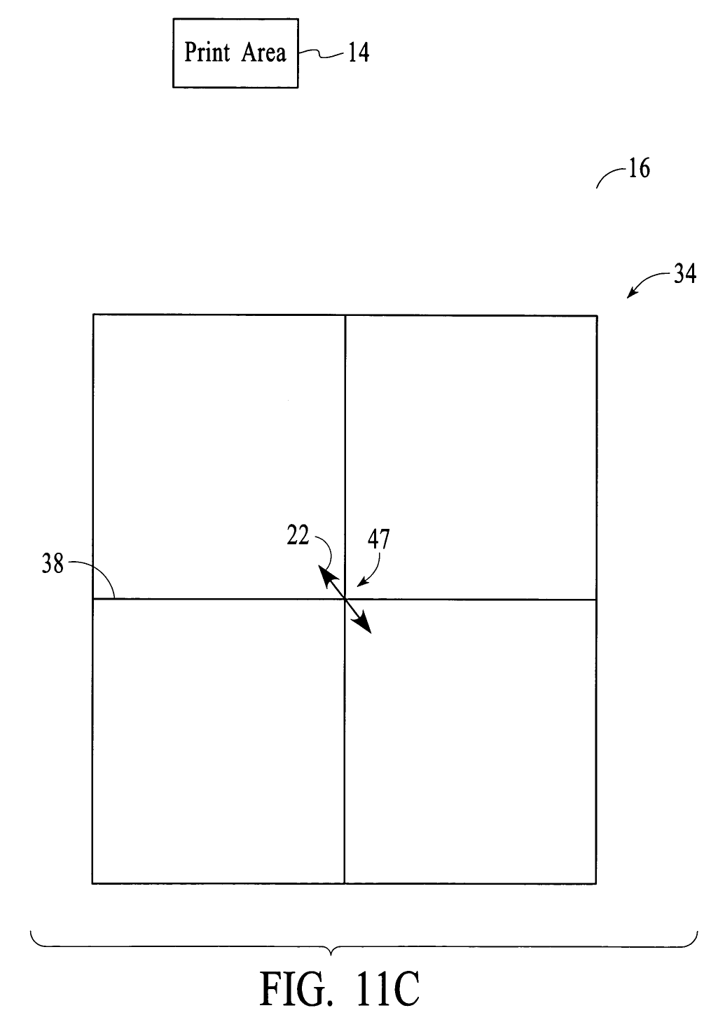

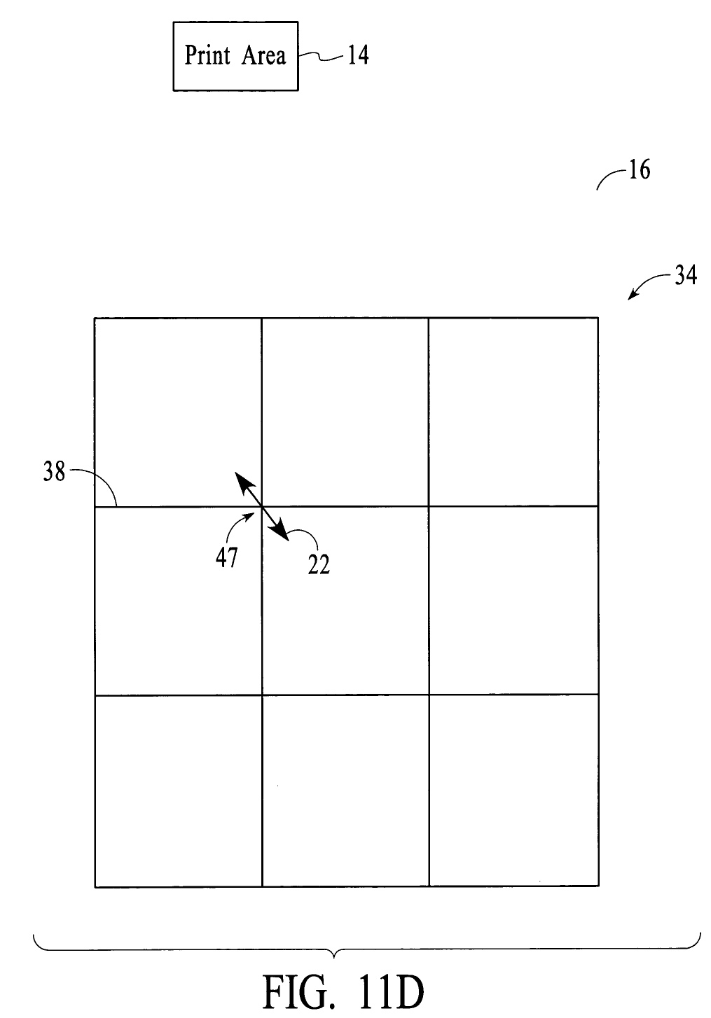

A multi-page mode PAR can also be created in a VDACC object by creating a single page mode PAR in the VDACC object or moving a single page mode PAR onto the VDACC object, and then snapping the VDACC object to the single page mode PAR using the “snap to” feature, as illustrated in FIG. 11A. In FIG. 11A, a VDACC object 34 that has been snapped to a single page mode PAR 12 is shown. The single page mode PAR 12 is then converted to a multi-page mode PAR 38 by activating the “multi page” entry in the associated Info Canvas object, as illustrated in FIG. 11B. In FIG. 11B, a horizontal line of the multi-page mode PAR 38 is shown, which can be seen by vertically scrolling the VDACC object 34, assuming that there is enough content in the VDACC object so that the VDACC object can be vertically scrolled. This horizontal line is the line that separates two vertically adjacent rectangles of the multi-page mode PAR 38. Thus, this horizontal line represents a page break between two pages that correspond to the two vertically adjacent rectangles. A vertical line of the multi-page mode PAR 38 may also be seen by vertically scrolling the VDACC object 34, assuming that there is enough content in the VDACC so that the VDACC can be horizontally scrolled.

As stated above, a multi-page mode PAR in the form of an array of rectangles is increased as the workspace canvas of a VDACC object is increased. Therefore, the PAR always fills the entire possible workspace canvas of a VDACC object. The current workspace canvas of the VDACC object can be viewed by scrolling the VDACC object. Thus, if the contents of the VDACC object fill twenty vertical pages, then a user can scroll the VDACC object to view these contents within twenty vertical rectangles of the multi-page mode PAR. Similarly, if the contents of the VDACC objects fill twenty horizontal pages, then a user can scroll the VDACC object to view these contents within twenty horizontal rectangles of the multi-page mode PAR. One interesting use of this multi-page mode PAR feature is that a vertical or horizontal banner can easily be made by simply printing the contents within the twenty vertical or horizontal rectangles of the multi-page PAR in the VDACC object.

When a multi-page mode PAR is created from a single page mode PAR with a VDACC object snapped to the PAR, the rectangle size of the multi-page mode PAR can be decreased such that multiple rectangles are positioned in the visible area of the VDACC object. As shown in FIG. 11B, when the cursor 22 is moved to an intersection 47 (or a corner of a rectangle) on the array 38, i.e., the multi-page mode PAR, the cursor is changed into a diagonal double arrow 22 at the intersection. This may require scrolling the VDACC object 34 to see the intersection 47. The rectangles of the multi-page mode PAR 38 can then be decreased in size by left-clicking on the mouse and dragging the double arrow cursor 22 diagonally in an upward and leftward direction. The rectangles of the multi-page mode PAR 38 can be made smaller such that four rectangles now occupy the same area for each original rectangle. Thus, four rectangles of the multi-page mode 38 can be viewed in the visible area of the VDACC object 34, as illustrated in FIG. 11C. Consequently, the contents in the visible area of the VDACC object 34 have been divided into four printable areas so that these contents can be printed on four different pages. The rectangles of the multi-page mode PAR can be further decreased in size in the same manner such that nine rectangles of the multi-page mode 38 now occupy the same area for each original rectangle, as illustrated in FIG. 11D, and so on. It is noted here that as the rectangles of the multi-page mode PAR 38 are decreased in size, the contents of the VDACC object 34 within the rectangles will be printed in proportionally larger sizes.

The printing sequence of pages using a multi-page mode PAR in a VDACC object may be user defined. In the exemplary embodiment, arrow logic and context may be used to select the printing sequence of contents within the rectangles of the multi-page mode PAR in the VDACC object. In the Blackspace environment, an arrow of a predefined color can be used to execute a predetermined function. In addition, the predetermined function can be dependent on the context in which the arrow is being used. The context is an arrow of predefined color (e.g., yellow) drawn in the multi-page mode PAR 38 that has been created from a single page mode PAR with a VDACC object snapped to the PAR. For more information regarding arrow logic and context, see pending U.S. patent application Ser. No. 09/880,397, entitled “Arrow Logic System for Creating and Operating Control Systems”, filed on Jun. 12, 2001, which is incorporated herein by reference.

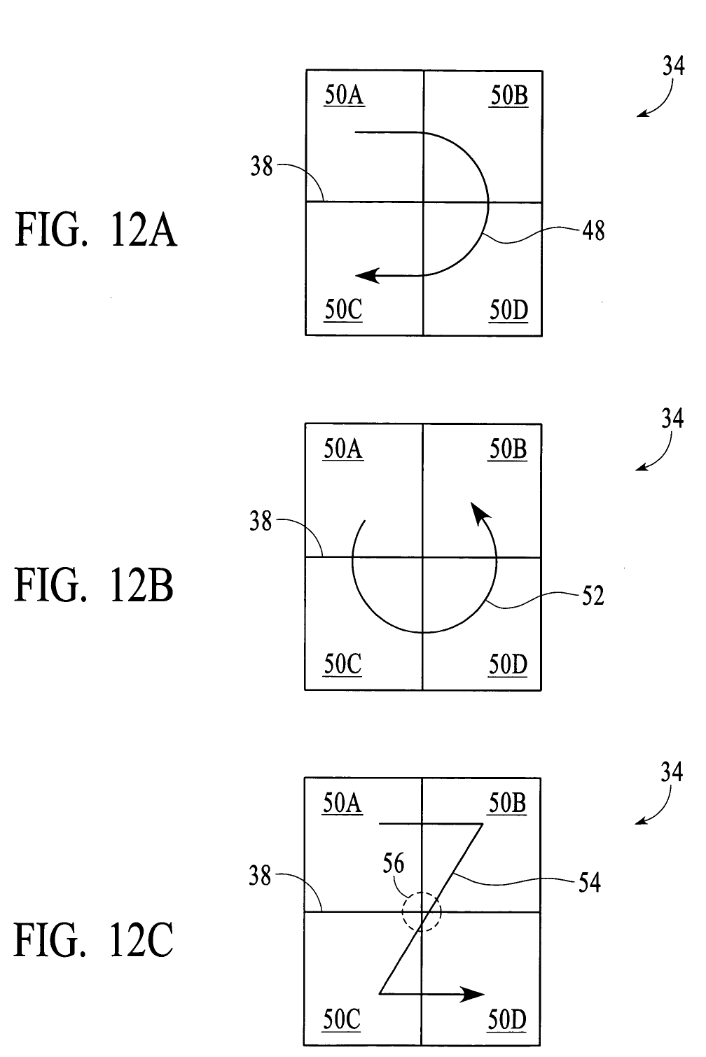

Using the described arrow logic and context, the printing sequence for the four rectangles of the multi-page mode PAR 38 shown in FIG. 11C, for example, can be selected by a user by drawing an arrow that intersects the four rectangles. The term “intersect” as used herein means that the arrow contacts any portion of a rectangle, such as the boundary of that rectangle. The order in which the arrow intersects the four rectangles of the multi-page mode PAR 38 will determine the printing sequence. Thus, the drawing of the arrow that intersects the four rectangles equates to the user selecting the rectangles in the order to be printed. As illustrated in FIG. 12A, if a clockwise arrow 48 is drawn from the rectangle 50A of the multi-page mode PAR 38 that intersects the four rectangles 50A-50D of the multi-page mode PAR, then the printing sequence will be defined in the following order: the rectangle 50A, the rectangle 50B, the rectangle 50D and the rectangle 50C. As illustrated in FIG. 12B, if a counterclockwise arrow 52 is drawn from the rectangle 50A of the multi-page mode PAR 38 that intersects the four rectangles 50A-50D of the multi-page mode PAR, then the printing sequence will be defined in the following order: the rectangle 50A, the rectangle 50C, the rectangle 50D and the rectangle 50B. As illustrated in FIG. 12C, if a Z-shaped arrow 54 is drawn from the rectangle 50A of the multi-page mode PAR 38 that intersects the four rectangles 50A-50D of the multi-page mode PAR, then the printing sequence will be defined in the following order: the rectangle 50A, the rectangle 50B, the rectangle 50C and the rectangle 50D. In order to allow a user to easily draw the diagonal portion of the arrow 54 such that the arrow intersects the rectangle 50B and then the rectangle 50C, an area 56 at the intersection of the four rectangles 50A-50D may be programmed such that an arrow logic is not recognized in this area. Thus, the arrow 54 is not interpreted as intersecting the rectangle 50D after the rectangle 50B since the arrow first intersects the rectangle 50D in the area 56.

In the exemplary embodiment, this printing sequence will also be applied to remaining rectangles of the multi-page mode PAR 38 on the workspace canvas of the VDACC object 34 in sets of four rectangles. For example, if there are eight more remaining rectangles on the workspace canvas of the VDACC object 34 below the current four rectangles 50A-50D, the next four rectangles will be printed in the same printing sequence, and then the remaining four rectangles will be printed in the same printing sequence.

D. “Actual Size” Feature in Multi Page Mode.

As described above, when a “multi page” PAR is in a VDACC object, the PAR is displayed in the form of an array of rectangles. If the “actual size” feature is then activated, the size of the array rectangles will be changed to the size of the actual printable area for the selected page size. In addition, similar to a single page PAR in a VDACC object, the width of the VDACC object is changed to the width size of the actual printable area, but the height of the VDACC object is not changed.

If there is not enough space on the screen to display the VDACC object in the same width size as the actual printable area, the viewable width of the VDACC object is set to the screen width a small border. Whenever, the VDACC object is not displayed in the same size as the actual printable area (width and/or length), an overview window is displayed to show the viewable area of the VDACC object in relation to the actual printable area.

Although the PAR has been described with respect to a VDACC object, the PAR may be used with any canvas object. As used herein, a canvas object is a graphic object that includes a workspace canvas or surface on which other graphic objects can be placed. The workspace canvas may be partially visible through a viewable area of the canvas object.

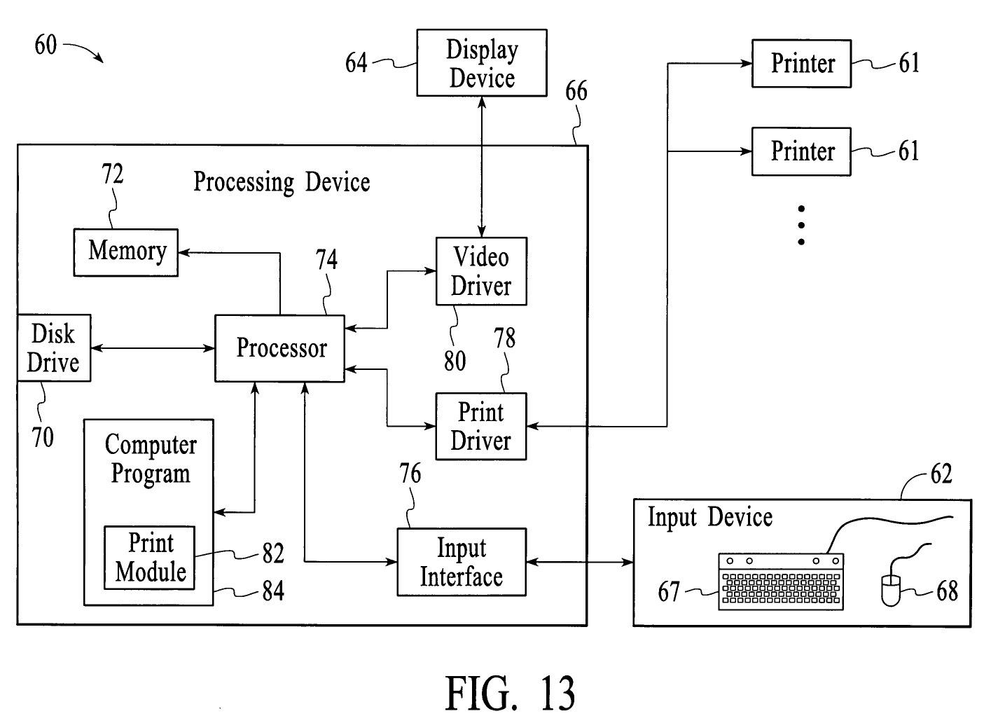

Turning now to FIG. 13, a computer system 60 in which the invention has been implemented is shown. The computer system 60 may be a personal computer, a personal digital assistant (PDA) or any computing system with a display device. The computer system 60 may be connected to one or more printers 61 for selectively printing displayed objects using the invention. In the exemplary embodiment, the invention may be embodied in a computer readable storage medium, such as a CD, that includes instructions, which can be executed by the computer system 60, to implement the invention in the system.

As illustrated in FIG. 13, the computer system 60 includes an input device 62, a display device 64 and a processing device 66. Although these devices are shown as separate devices, two or more of these devices may be integrated together. The input device 62 allows a user to input commands into the system 60 to, for example, draw or create a PAR. In the exemplary embodiment, the input device 62 includes a computer keyboard 67 and a mouse 68, as shown in FIG. 13. However, the input device 62 may be any type of electronic input device, such as buttons, dials, levers and/or switches on the processing device 66. Alternative, the input device 62 may be part of the display device 64 as a touch-sensitive display that allows a user to input commands using a stylus. The display device 62 may be any type of a display device, such as those commonly found in personal computer systems, e.g., CRT monitors or LCD monitors.

The processing device 66 of the computer system 60 includes a disk drive 70, memory 72, a processor 74, an input interface 76, a print driver 78 and a video driver 80. The processing device 64 further includes a print module 82 that performs various functions associated with the invention. As shown in FIG. 13, the print module 82 is implemented as part of a computer program 84, e.g., a Blackspace program that provides the Blackspace operating environment. In the exemplary embodiment, the print module 82 is implemented as software. However, the print module 82 may be implemented in any combination of hardware, firmware and/or software.

The disk drive 70, the memory 72, the processor 74, the input interface 76, the print driver 76 and the video driver 80 are components that are commonly found in personal computers. The disk drive 70 provides a means to input data and to install programs into the system 60 from an external computer readable storage medium. As an example, the disk drive 70 may a CD drive to read data contained therein. The memory 72 is a storage medium to store various data utilized by the computer system 60. The memory may be a hard disk drive, read-only memory (ROM) or other forms of memory. The processor 74 may be any type of digital signal processor that can run the computer program 84, including the print module 82. The input interface 76 provides an interface between the processing device 66 and the input device 62. The print driver 67 drives the printers 61 connected to the computer system 60 using print driver data. The video driver 80 drives the display device 64. In order to simplify the figure, additional components that are commonly found in a processing device of a personal computer system are not shown or described.

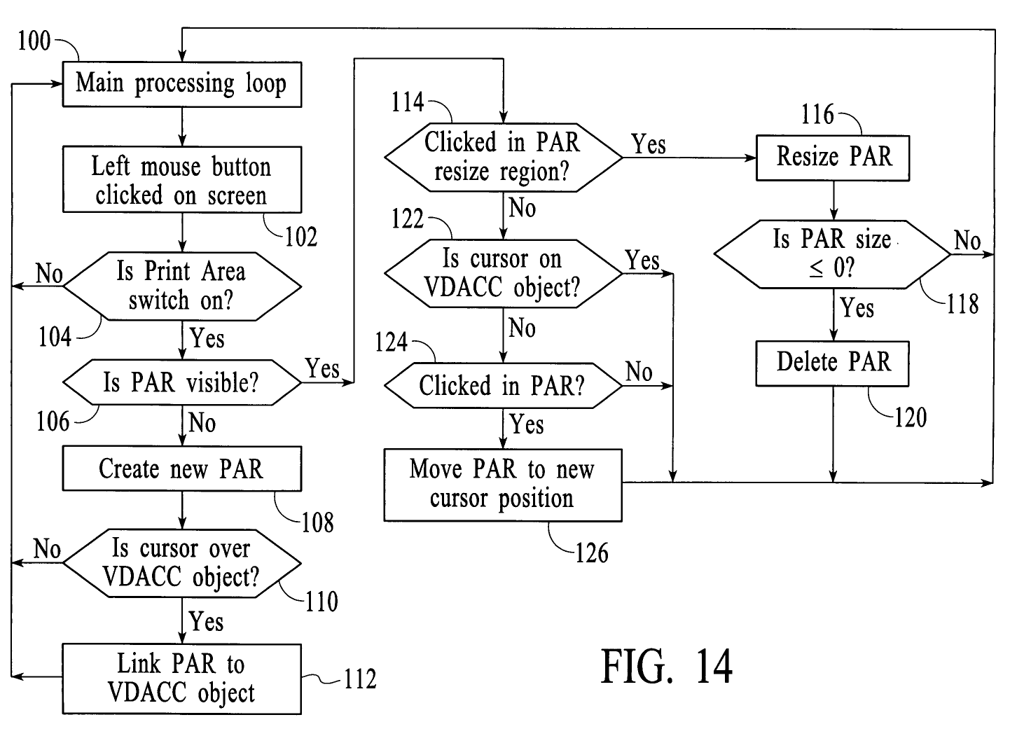

Various operations of the invention as implemented as part of the Blackspace program are described with reference to the flow charts of FIGS. 14-18. In FIG. 14, a flow chart of a process for handling a left mouse click event in the Blackspace environment is shown. Block 100 represents the main processing loop of the Blackspace program. All mouse click events are handled in the main processing loop. For instance, if a mouse button is clicked, the main processing loop will send out a message to all objects that the mouse button has been pressed. Each object can then determine if the message was intended for that object or not. If the message is handled or not, the processing is always returned to this main processing loop.

At block 102, the left mouse button is clicked somewhere on the screen by a user. Next, at block 104, a determination is made whether the Print Area switch is activated. This is a simple check to see if the Print Area switch is on. If yes, then there is a chance that the received message is for the print module, and thus, the process continues to block 106. However, if the Print Area switch is not on, the received message is returned back to the main processing loop, and thus, the process returns to block 100.

At block 106, another determination is made whether the PAR is visible. This is a check to see if the PAR has been defined by the user yet. If not, until the PAR is created, there is nothing for the print module to do. Therefore, the PAR must first be created. If the PAR is visible, then the PAR may be resized or moved as a result of the left mouse button click event.

If the PAR is not visible, the process proceeds to block 108, where a new PAR is created by the user. The PAR is created by the user clicking the left mouse button down and dragging the cursor diagonally. The PAR must be more than 20 pixels in width to register with the print module. Anything smaller than the predefined width is ignored by the print module. The size of the PAR can be made larger or smaller by moving the cursor diagonally while the left mouse button is clicked down. When the user releases the left mouse button, the size of the PAR is defined and the PAR will continue to be visible on the screen.

Next, at block 110, a determination is made whether the mouse cursor is over a VDACC object. If yes, the PAR will link or attach to the VDACC object, at block 112. The process then proceeds back to the main processing loop. If the mouse cursor is not over a VDACC object, then the process proceeds directly back to the main processing loop.

Turning back to block 106, if the PAR is visible, then the process proceeds to block 114, where a determination is made whether the user clicked in the PAR resize region. This is a check to determine whether the mouse is over this area when the left mouse was clicked. If yes, at block 116, the PAR is resized according to where the user has released the left mouse button, which determines the size of the PAR.

Next, at block 118, a determination is made whether the size of the PAR is less than or equal to zero. If yes, then the PAR is deleted, at block 120, and the process proceeds back the main processing loop. If the size of the PAR is greater than zero, then the processes proceeds directly back to the main processing loop.

If, at block 114, it is determined that the user has not clicked in the PAR resize region, then the process proceeds to block 122, where another determination is made whether the cursor is on a VDACC object. If yes, then there is nothing for the print module to process. That is, if the PAR is not being resized and the user has clicked on the left mouse button when the PAR is attached to a VDACC object, then there is nothing for the print module to do. Thus, the process then proceeds back to the main processing loop.

If the cursor is not on a VDACC object, a determination is made whether the cursor is in the PAR when the left mouse button was clicked, at block 124. If yes, then the PAR is moved to the new cursor position, at block 126, and the process proceeds back to the main processing loop. If the cursor is not in the PAR, then the process proceeds directly back to the main processing loop.

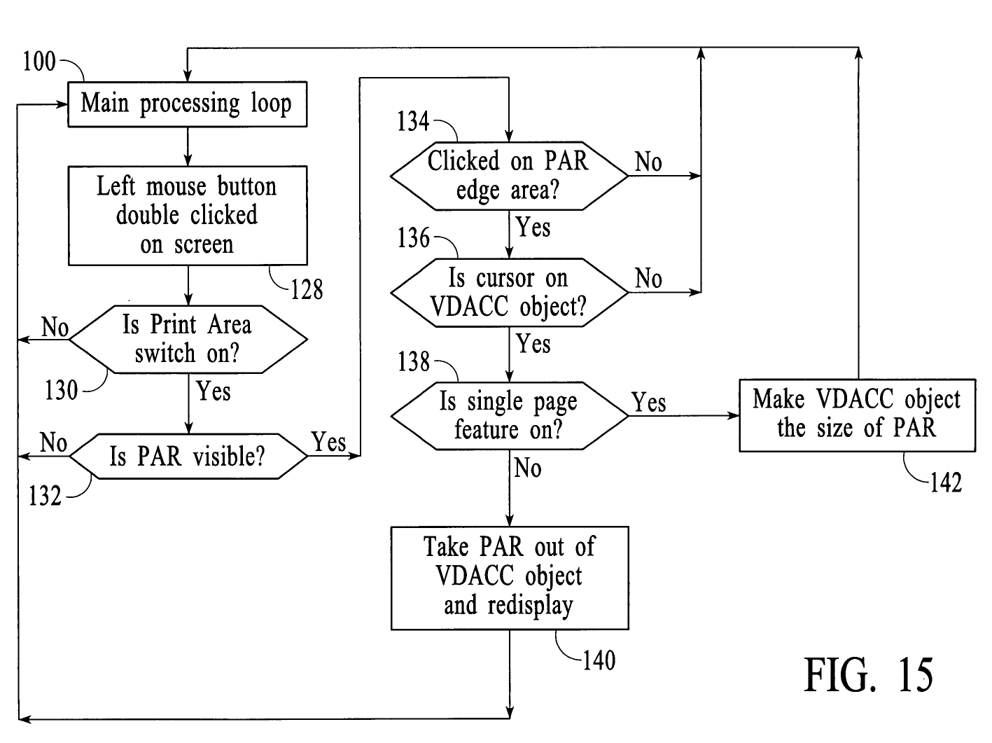

In FIG. 15, a flow chart of a process for handling a double left mouse click event in the Blackspace environment is shown. Again, block 100 represents the main processing loop for the Blackspace program. At block 128, the left mouse button is double clicked somewhere on the screen by a user. Next, at block 130, a determination is made whether the Print Area switch is activated. If no, then the process proceeds back to the main processing loop. If yes, then another determination is made whether the PAR is visible, at block 132. If no, then the process proceeds back to the main processing loop.

If the PAR is visible, then a determination is made whether the cursor is on the PAR edge area when the left mouse button was double clicked. If no, then the process proceeds back to the main processing loop. If the cursor is on the PAR edge area, then another determination is made whether the cursor is on a VDACC object, at block 136. If no, then the process proceeds back to the main processing loop. If the cursor is on a VDACC object, the process proceeds to block 138.

At block 138, another determination is made whether the single page feature is activated. If no, the PAR is taken out of the VDACC object and redisplayed on the Blackspace canvas in the “multi page” mode, at block 140. If the single page feature is activated, then the size of the VDACC object is made to equal the size of the PAR, at block 142. If the screen is too small to fit the VDACC object, then the VDACC object will be made to fit the screen. The VDACC object will also be enlarged to include dead space if the contents of the VDACC object are not enough. The viewable area of the VDACC object represents a portion of the page, when the VDACC object is increased in size, the VDACC object does not appear any bigger on screen, only the area which a user can scroll. If there are no objects within this hidden area, this is called dead space. The process then proceeds back to the main processing loop.

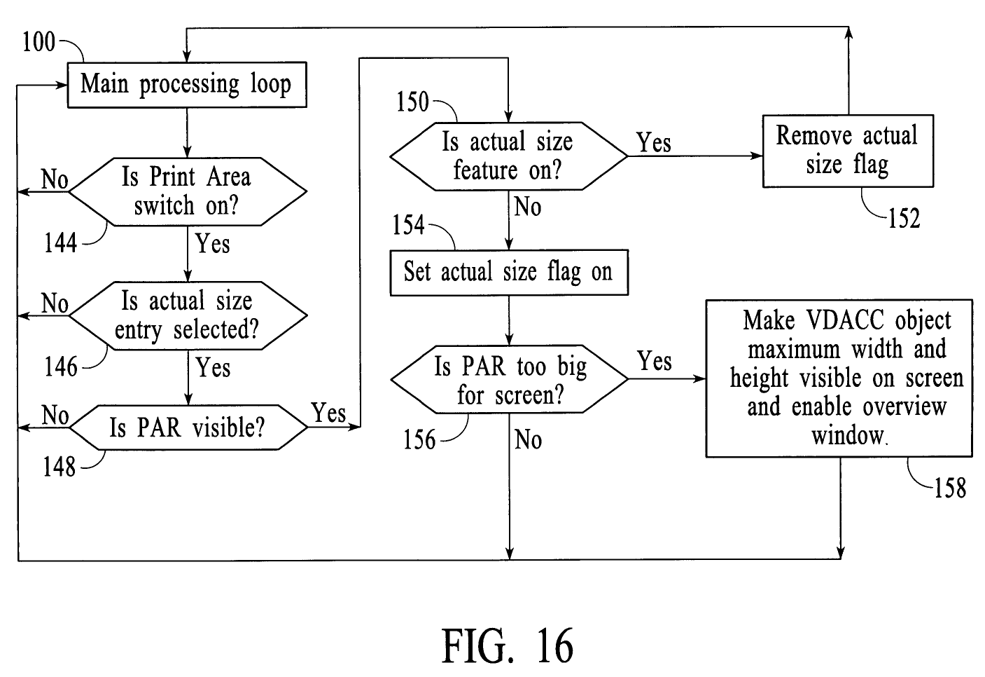

In FIG. 16, a flow chart of a process for handling the activation of actual size feature is shown. Again, block 100 represents the main processing loop for the Blackspace program. At block 144, a determination is made whether the Print Area switch is activated. If no, then the process proceeds back to the main processing loop. If the Print Area switch is activated, then another determination is made whether the actual size entry is selected from the Info Canvas object for the Print Area switch, at block 146. If no, then the process proceeds back to the main processing loop. If the actual size entry is selected, then the process proceeds to block 148.

At block 148, a determination is made whether the PAR is visible. The PAR may be visible with an overview window. If no, then the process proceeds back to the main processing loop. If the PAR is visible, then another determination is made whether the actual size feature is activated, at block 150. This is a check to see if the actual size feature is already activated. If yes, then the actual size flag is removed, at block 152, and the process proceeds back to the main processing loop. At block 152, if the overview window is currently displayed, the overview window is also removed.

If the actual size feature is not activated, then the actual size flag is set to let the system know that the actual size feature is now activated, at block 154. Next, at block 156, a determination is made whether the PAR is too big for the screen. If no, then the process proceeds back to the main processing loop. However, if the PAR is too big for the screen, then the width of the VDACC object is made to fit the screen and the overview window is enabled (displayed), at block 158. The process then proceeds back to the main processing loop.

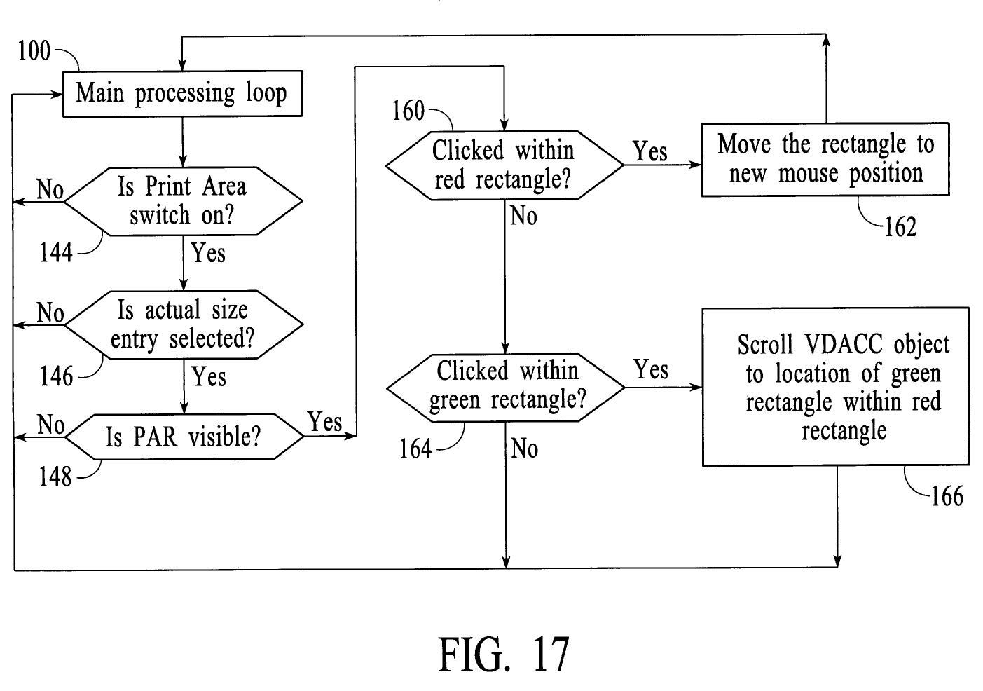

In FIG. 17, a flow chart of a process for handling a left mouse button click event on an overview window is shown. Blocks 100, 144, 146 and 148 in the flow chart of FIG. 17 are similar to the same referenced blocks in the flow chart of FIG. 16. Thus, those blocks are not described again. At block 148, if it is determined that the PAR is visible, then a determination is made whether the left mouse button was clicked when the cursor is within the larger rectangle of the overview window, e.g., the red rectangle, at block 160. If yes, then the larger rectangle is moved to the new mouse position where the left mouse button is released, at block 162, and the process proceeds back to the main processing loop.

If the left mouse button was not clicked within the larger rectangle of the overview window, then another determination is made whether the left mouse button was clicked when the cursor is within the smaller rectangle of the overview window, e.g., the green rectangle, at block 164. If no, then the process proceeds back to the main processing loop. If the left mouse button was clicked within the smaller rectangle of the overview window, then the VDACC object is scrolled to the region of the PAR that corresponds to the location of the smaller rectangle of the overview window within the larger rectangle of the overview window, at block 166. The process then proceeds back to the main processing loop.

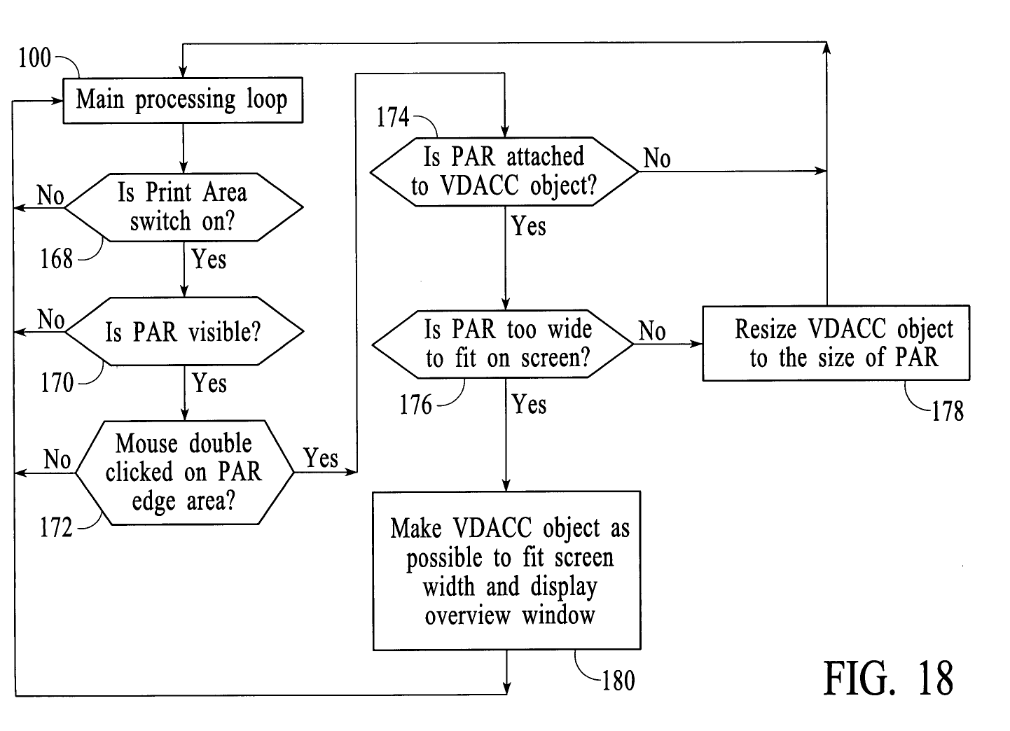

In FIG. 18, a flow chart of a process for handling a double left mouse click event to activate the “snap to” feature is shown. At block 100, the main processing loop of the Blackspace program is performed. At block 168, a determination is made whether the Print Area switch is activated. If no, then the process proceeds back to the main processing loop. If the Print Area switch is activated, then another determination is made whether the PAR is visible, at block 170. If no, then the process proceeds back to the main processing loop. If the PAR is visible, then the process proceeds to block 172.

At block 172, a determination is made whether a double left mouse click event on the edge area of the PAR has occurred. If no, then the process proceeds back to the main processing loop. If a double left mouse click event on the PAR edge area has occurred, then another determination is made whether the PAR is attached to a VDACC object, at block 174. If no, then the process proceeds back to the main processing loop. If the PAR is attached to a VDACC object, then a determination is made whether the PAR is too wide to fit on the screen, block 176. If no, then the VDACC object is resized to the size of the PAR, at block 178. The process then proceeds back to the main processing loop.

If the PAR is too wide to fit on the screen, then the VDACC object is made as wide as possible to fit the width of the screen and the overview window is enabled (displayed), at block 180. The process then proceeds back to the main processing loop.

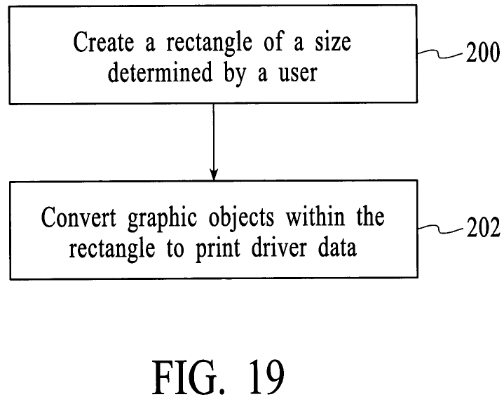

A method for selectively printing displayed graphic objects in accordance with an embodiment of the invention is described with reference to a flow diagram of FIG. 19. At block 200, a rectangle of a size determined by a user is created on a display device. The rectangle defines an area of the display device to be printed on a selected print medium. The rectangle also represents the actual printable area of the selected print medium. Next, at block 202, the graphic objects within the rectangle are converted to print driver data to print these graphic objects on the selected print medium. In other embodiments, the rectangle may be other geometric objects.

Although specific embodiments of the invention have been described and illustrated, the invention is not to be limited to the specific forms or arrangements of parts so described and illustrated. The scope of the invention is to be defined by the claims appended hereto and their equivalents.

1. A method for selectively printing graphic objects displayed on a display device, said method comprising:
creating a geometric object of a size determined by a user, said geometric object defining an area of said display device to be printed on a selected print medium; and
converting said graphic objects within said geometric object to print driver data to print said graphic objects within said geometric object on said selected print medium.

2. The method of claim 1 wherein said converting includes converting a portion of a graphic object that is partially within said geometric object so that said portion of said graphic object is printed on said selected print medium.

3. The method of claim 1 wherein said converting includes resealing said graphic objects within said geometric object such that said graphic objects within said geometric object when printed on a printable area of said selected print medium are in the same proportion to said printable area as said graphic objects displayed on said display device are to said geometric object.

4. The method of claim 1 further comprising changing a size of said geometric object without changing sizes of said graphic objects within said geometric object to correspondingly change said sizes of said graphic objects within said geometric object when printed on said print medium.

5. The method of claim 4 wherein said changing includes changing said size of said geometric object displayed on said display device to an actual printable area size of said print medium in response to a user activation of an actual size feature of said geometric object.

6. The method of claim 4 wherein said changing includes diagonally moving a cursor to select the size of said geometric object.

7. The method of claim 1 further comprising moving said geometric object on said display device to define a new corresponding area of said display device to be printed.

8. The method of claim 1 further comprising deleting said geometric object by moving a cursor from one corner of said geometric object to another corner of said geometric object.

9. The method of claim 1 wherein said creating includes creating an array of geometric objects, each of said geometric objects of said array representing a printable area of print media.

10. The method of claim 1 further comprising converting said geometric object into an array of geometric objects in response to a multiple page feature of said geometric object, each of said geometric objects of said array representing a printable area of print media.

11. The method of claim 1 further comprising linking said geometric object to a canvas object having a surface that may be partially viewable.

12. The method of claim 11 further comprising scrolling said geometric object with contents of said canvas object when a locking feature of said geometric object is activated.

13. The method of claim 11 further comprising scrolling contents of said canvas object without moving said geometric object when a locking feature of said geometric object is not activated.

14. The method of claim 11 wherein said creating includes creating an array of geometric objects on said surface of said canvas object, each of said geometric objects of said array representing a printable area of print media.

15. The method of claim 11 further comprising converting said geometric object into an array of geometric objects on said surface of said canvas object, each of said geometric objects of said array representing a printable area of print media.

16. The method of claim 11 further comprising changing sizes of said geometric objects of said array displayed on said display device without changing a size of any content in said canvas object.

17. The method of claim 16 wherein said changing includes changing said sizes of said geometric objects of said array displayed on said display device to actual printable area sizes of print media in response to a user activation of an actual size feature of said array of geometric objects.

18. The method of claim 11 further comprising changing a width size of said canvas object to equal a width size of said geometric object in response to a user activation of a snap to feature.

19. The method of claim 11 further comprising selecting some of said geometric objects of said array in an order to define a printing sequence for at least some of said geometric objects.

20. A graphical user interface for selectively printing graphic objects displayed on a display device, said graphic user interface comprising:
a surface on which said graphic objects are displayed; and
a geometric object on said surface that represents a printable area of a selected print medium, said geometric object being user-manipulable with respect to at least a creation of said geometric object on said surface, said geometric object defining an area of said surface to be printed on said selected print medium to enable printing of said graphic objects within said geometric object.

21. The graphic user interface of claim 20 wherein said geometric object is configured such that a portion of a graphic object that is partially within said geometric object is printed on said selected print medium when said geometric object is activated for printing.

22. The graphic user interface of claim 20 wherein said geometric object is user-manipulable with respect to size of said geometric object such that said size of said geometric object can be changed without changing sizes of said graphic objects within said geometric object.

23. The graphic user interface of claim 20 wherein said geometric object is configured to change said size of said geometric object displayed on said display device to an actual printable area size of said print medium in response to a user activation of an actual size feature of said geometric object.

24. The graphic user interface of claim 22 wherein said geometric object is configured to be changed in size in response to a diagonal movement of a cursor under a predefined condition.

25. The graphic user interface of claim 20 wherein said geometric object is configured to be user-manipulable with respect to a position of said geometric object such that said geometric object can be moved on said display device to define a new corresponding area of said display device to be printed.

26. The graphic user interface of claim 20 wherein said geometric object is configured to be deleted from said display device in response to a movement of a cursor from one corner of said geometric object to another corner of said geometric object under a predefined condition.

27. The graphic user interface of claim 20 wherein said geometric object is part of an array of geometric objects, each of said geometric objects of said array representing a printable area of print media.

28. The graphic user interface of claim 20 wherein said geometric object is configured to be converted into an array of geometric objects in response to an activation of a multiple page feature of said geometric object, each of said geometric objects of said array representing a printable area of print media.

29. The graphic user interface of claim 20 further comprising a canvas object having a surface that may be partially viewable, said geometric object being configured to be linked to said canvas object when said geometric object is in said canvas object.

30. The graphic user interface of claim 29 wherein said geometric object in said canvas object is configured to be scrolled with contents of said canvas object when a locking feature of said geometric object is activated.

31. The graphic user interface of claim 29 wherein said geometric object in said canvas object is configured to be stationary when contents of said canvas object are scrolled when a locking feature of said geometric object is not activated.

32. The graphic user interface of claim 29 wherein said geometric object is part of an array of geometric objects on said surface of said canvas object, each of said geometric objects of said array representing a printable area of print media.

33. The graphic user interface of claim 29 wherein said geometric object in said canvas object is configured to be converted into an array of geometric objects on said surface of said canvas object in response to a multiple page feature, each of said geometric objects of said array representing a printable area of print media.

34. The graphic user interface of claim 33 wherein said array of geometric objects is configured such that sizes of said geometric objects of said array displayed on said display device can be changed without changing a size of any content in said canvas object.

35. The graphic user interface of claim 34 wherein said array of geometric objects is configured such that said sizes of said geometric objects of said array displayed on said display device are changed to actual printable area sizes of print media in response to a user activation of an actual size feature of said array of geometric objects.

36. The graphic user interface of claim 29 wherein said geometric object in said canvas object is configured such that the width size of said canvas object can be changed to equal the width size of said geometric object in response to a user activation of a snap to feature.

37. A storage medium readable by a computer, tangibly embodying a program of instructions executable by said computer to perform method steps for selectively printing graphic objects displayed on a display device, said method steps comprising:
creating a geometric object of a size determined by a user, said geometric object defining an area of said display device to be printed on a selected print medium; and
converting said graphic objects within said geometric object to print driver data to print said graphic objects within said geometric object on said selected print medium.

38. The storage medium of claim 37 wherein said converting includes converting a portion of a graphic object that is partially within said geometric object so that said portion of said graphic object is printed on said selected print medium.

39. The storage medium of claim 37 wherein said converting includes rescaling said graphic objects within said geometric object such that said graphic objects within said geometric object when printed on a printable area of said selected print medium are in the same proportion to said printable area as said graphic objects displayed on said display device are to said geometric object.

40. The storage medium of claim 37 further comprising changing a size of said geometric object without changing sizes of said graphic objects within said geometric object to correspondingly change said sizes of said graphic objects within said geometric object when printed on said print medium.

41. The storage medium of claim 40 wherein said changing includes changing said size of said geometric object displayed on said display device to an actual printable area size of said print medium in response to a user activation of an actual size feature of said geometric object.

42. The storage medium of claim 40 wherein said changing includes diagonally moving a cursor to select the size of said geometric object.

43. The storage medium of claim 37 further comprising moving said geometric object on said display device to define a new corresponding area of said display device to be printed.

44. The storage medium of claim 37 further comprising deleting said geometric object by moving a cursor from one corner of said geometric object to another corner of said geometric object.

45. The storage medium of claim 37 wherein said creating includes creating an array of geometric objects, each of said geometric objects of said array representing a printable area of print media.

46. The storage medium of claim 37 further comprising converting said geometric object into an array of geometric objects in response to a multiple page feature of said geometric object, each of said geometric objects of said array representing a printable area of print media.

47. The storage medium of claim 37 further comprising linking said geometric object to a canvas object having a surface that may be partially viewable.

48. The storage medium of claim 47 further comprising scrolling said geometric object with contents of said canvas object when a locking feature of said geometric object is activated.

49. The storage medium of claim 47 further comprising scrolling contents of said canvas object without moving said geometric object when a locking feature of said geometric object is not activated.

50. The storage medium of claim 47 wherein said creating includes creating an array of geometric objects on said surface of said canvas object, each of said geometric objects of said array representing a printable area of print media.

51. The storage medium of claim 47 further comprising converting said geometric object into an array of geometric objects on said surface of said canvas object, each of said geometric objects of said array representing a printable area of print media.

52. The storage medium of claim 47 further comprising changing sizes of said geometric objects of said array displayed on said display device without changing a size of any content in said canvas object.

53. The storage medium of claim 52 wherein said changing includes changing said sizes of said geometric objects of said array displayed on said display device to actual printable area sizes of print media in response to a user activation of an actual size feature of said array of geometric objects.

54. The storage medium of claim 47 further comprising changing a width size of said canvas object to equal a width size of said geometric object in response to a user activation of a snap to feature.

55. The storage medium of claim 47 further comprising selecting some of said geometric objects of said array in an order to define a printing sequence for at least some of said geometric objects.
